(19) United States
(12) Patent Application Publication
(10) Pub. No.: US 2004/0260788 A1
(43) Pub. Date: Dec. 23, 2004

(54) Information provision system, terminal unit and relay unit forming part of that system, and image display customizing system

(76) Inventors: Kazuhiko Miyano, Kobe-shi (JP); Shouji Ueoka, Kobe-shi (JP); Toshikazu Nakahira, Kobe-shi (JP); Hideo Asami, Kobe-shi (JP); Junichi Sawada, Kobe-shi (JP); Toshiharu Araki, Kobe-shi (JP); Satoru Nakae, Kobe-shi (JP); Tadayuki Yamashita, Kobe-shi (JP); Teru Sawada, Kobe-shi (JP); Kanako Fujiwara, Kobe-shi (JP); Isao Hamada, Kobe-shi (JP); Satoru Nagamoto, Kobe-shi (JP); Shunsuke Uchi, Kobe-shi (JP)

Correspondence Address: CHRISTIE, PARKER & HALE, LLP, PO BOX 7068, PASADENA, CA, 91109-7068, US

(21) Appl. No.: 10/857,466

(22) Filed: May 28, 2004

(30) Foreign Application Priority Data
May 30, 2003 (JP) 2003-154482
Jul. 23, 2003 (JP) 2003-278459

(51) Int. Cl. H04B 7/185

(52) U.S. Cl. 709/217

(57) ABSTRACT

An information provision system provided with a terminal unit and a relay unit, wherein the relay unit has an information holding function unit for holding fixed basic information and individual user customizable additional information, the terminal unit has an additional command transmitting function unit for transmitting information addition commands, and the relay unit is provided with an information processing function unit for obtaining additional information corresponding to the received information addition command and combining it with the basic information and transmits the combined processed information to the terminal unit, a terminal unit and relay unit forming part of that system, and an image display customizing system.

### BACKGROUND OF THE INVENTION

1. Field of the Invention

The present invention relates to an information provision system, for example, an information provision system for providing multimedia information or map information in a car navigation system, a terminal unit and relay unit forming part of that system, and an image display customizing system.

The present invention is not limited to an information provision system operating via a car-mounted terminal unit such as a car navigation system and can also be applied to an information provision system operating via a personal computer (PC) provided in the home, but here the explanation will be made taking as an example the above car navigation system.

2. Description of the Related Art

Vehicular information provision systems such as car navigation systems were initially designed to hold road, terrain, and other map information in advance in CD-ROMs or DVDS carried in the vehicles, read out the map information held in the vehicles, display it on display units, and mark the positions of the vehicles on the map data.

Later, however, mobile phones utilizing mobile communication networks rapidly spread in use. Now, communication-type car navigation systems not holding data of the above map information in the vehicles, but downloading that information from server apparatuses holding the navigation information through mobile communication networks and Internet protocol (IP) networks are becoming the mainstream.

According to the above communication-type car navigation systems, there is no longer any need for each car-mounted terminal unit to hold an enormous amount of map information, so the advantage accrues that the space and cost for installation of the digital versatile disk (DVD) or other recording media become unnecessary.

Further, the server apparatuses can be easily updated in information, so there is the advantage that traffic congestion information, various event information, and other information requiring real time properties can be provided to the vehicle users on-line.

As a known publication relating to such recent communication-type car navigation systems, there is for example Japanese Unexamined Patent Publication (Kokai) No. 2002-107169.

Summarizing the problems to be solved by the invention, as described in Japanese Unexamined Patent Publication (Kokai) No. 2002-107169 as well, it is necessary for each car-mounted terminal unit and the server apparatus to communicate with each in a dialog format with a considerable frequency.

Therefore, in Japanese Unexamined Patent

Publication (Kokai) No. 2002-107169, measures are taken to cut the amount of communication and a dedicated navigation server, that is, a dedicated server, is introduced to transmit map information and point of information (POI) in response to requests from vehicle users.

In Japanese Unexamined Patent Publication (Kokai) No. 2002-107169, however, there were the following two problems:

(1) The first problem can be found in the construction of the above dedicated server containing the map database, POI, etc. Therefore, the cost ends up rising by the amount of the map database and POI.

If not constructing such a dedicated server, it would be necessary to obtain the required various types of navigation information from a plurality of general use servers by individual accesses. That is, a car-mounted terminal unit would have to individually access each of the plurality of general use servers. With this, the communication costs would end up increasing by the number of accesses. Further, only naturally, the number of times the user would have to operate the terminal unit for access would increase by the number of accesses. This would not be desirable from the viewpoint of driving safety.

In short, there is the problem that communication costs would end up increasing due to the individual accesses to a plurality of general use servers.

The second problem is that extraneous data also ends up being obtained.

That is, when the car-mounted terminal unit obtains various navigation information from the above plurality of general use servers, it ends up obtaining data not directly required by it. This “not directly required data” is for example detailed data designed for PCs etc.

In short, there is the problem that the communication costs end up increasing by the access of an amount of data not directly related to the navigation, that is, the extraneous data.

### SUMMARY OF THE INVENTION

An object of the present invention is to provide an information provision system, terminal unit, and relay unit able to suppress an increase in communication costs due to individual accesses of a plurality of servers or due to extraneous data.

Another object of the present invention is to provide an image display customizing system particularly suitable for moving pictures in such an information provision system.

To attain the above first object, according to a first aspect of the present invention, there is provided an information provision system provided with a terminal unit (2) and a relay unit (3), wherein the relay unit (2) has an information holding function unit (4) for holding fixed basic information (11) and individual user customizable additional information (12), the terminal unit (2) has an additional command transmitting function unit (11) for transmitting information addition commands CM, and the relay unit (3) is provided with an information processing function unit (13) for obtaining additional information (12) corresponding to the received information addition command and combining it with the basic information (12) and transmits the combined processed information (13) to the terminal unit (2). Due to this, an information provision system processing information customized in accordance with user requirements in a relay unit and providing it to a user terminal unit can be realized.

To attain the second object, according to a second aspect of the present invention, there is provided an image display customizing system particularly effective for dealing with moving pictures, comprising having a car-mounted device (22) transmit identifying information of the car-mounted device to a PC and having the PC transmit the identifying information of the car-mounted device and previously input and stored image information through the Internet (IN) (23) to a server (26). The server converts the image information received through the Internet to match with the image display specifications of the car-mounted device specified by the identifying information of the car-mounted device received through the Internet and transmits the converted image information to the PC. The converted information from the PC is transmitted to the car-mounted device by a memory stick (25), so the car-mounted device can display the image information on its display unit (29). Due to this, it becomes possible to display any image information, regardless of the image display specifications of the car-mounted device, on the display unit of the car-mounted device.

### BRIEF DESCRIPTION OF THE DRAWINGS

These and other objects and features of the present invention will become clearer from the following description of the preferred embodiments given with reference to the attached drawings, wherein:

FIG. 1 is a view of the basic configuration of an information provision system according to the present invention;

FIG. 2 is a view of an example of an information provision system showing the basic configuration of FIG. 1 in somewhat more detail;

FIG. 3 is a sequence diagram of a first mode of transfer of information in the information provision system;

FIG. 4 is a sequence diagram of a second mode of transfer of information in the information provision system;

FIG. 5 is a sequence diagram of a third mode of transfer of information in the information provision system;

FIG. 6 is a sequence diagram of a fourth mode of transfer of information in the information provision system;

FIG. 7 is a sequence diagram of a fifth mode of transfer of information in the information provision system;

FIG. 8 is a sequence diagram of a sixth mode of transfer of information in the information provision system;

FIG. 9 is a sequence diagram of a seventh mode of transfer of information in the information provision system;

FIG. 10 is a sequence diagram of an eighth mode of transfer of information in the information provision system;

FIG. 11 is a sequence diagram of a ninth mode of transfer of information in the information provision system;

FIG. 12 is a sequence diagram of a 10th mode of transfer of information in the information provision system;

FIG. 13 is a sequence diagram of an 11th mode of transfer of information in the information provision system;

FIG. 14 is a sequence diagram of a 12th mode of transfer of information in the information provision system;

FIG. 15 is a sequence diagram of a 13th mode of transfer of information in the information provision system;

FIG. 16 is a sequence diagram in the case of constructing the information provision system by a plurality of servers;

FIG. 17 is a sequence diagram in the case of application of the second mode (FIG. 4);

FIG. 18 is a sequence diagram in the case of application of the fourth mode (FIG. 6);

FIG. 19 is a first part of a flow chart of the operation in the case of execution of the modes shown in FIGS. 5, 6, 7, 14, and 15;

FIG. 20 is a second part of a flow chart of the operation in the case of execution of the modes shown in FIGS. 5, 6, 7, 14, and 15;

FIG. 21 is a first part of a flow chart of the operation in the case of execution of the modes shown in FIGS. 5, 9, 11, 12, and 13;

FIG. 22 is a second part of a flow chart of the operation in the case of execution of the modes shown in FIGS. 5, 9, 11, 12, and 13;

FIG. 23 is a third part of a flow chart of the operation in the case of execution of the modes shown in FIGS. 5, 9, 11, 12, and 13;

FIG. 24 is a first part of a flow chart of the operation in the case of execution of the modes shown in FIGS. 16 and 17;

FIG. 25 is a second part of a flow chart of the operation in the case of execution of the modes shown in FIGS. 16 and 17;

FIG. 26 is a first part of a flow chart of the operation in the case of execution of the mode shown in FIG. 18;

FIG. 27 is a second part of a flow chart of the operation in the case of execution of the mode shown in FIG. 18;

FIGS. 28A and 28B are views illustrating first and second models of terminal transmitted information;

FIG. 29 is a view of a sequence of communication between a terminal unit and a relay unit;

FIG. 30 is a view of the system configuration showing a modification of the relay unit (server);

FIG. 31 is a block diagram of an example of the configuration of an image display customizing system of a car-mounted device using a communication network;

FIGS. 32A and 32B are flow charts for explaining an image information conversion and image display operation of the image display customizing system; and

FIG. 33 is a block diagram of an example of the configuration of another image display customizing system.

### DESCRIPTION OF THE PREFERRED EMBODIMENTS

Preferred embodiments of the present invention will be described in detail below while referring to the attached figures.

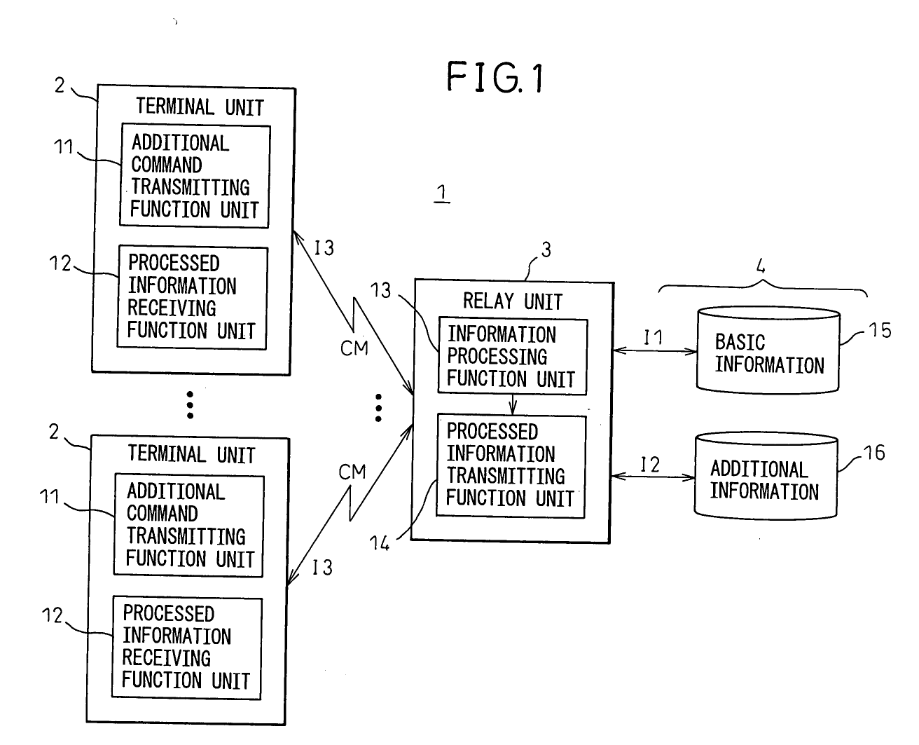

FIG. 1 is a view of the basic configuration of an information provision system according to the present invention.

In the figure, the information provision system is shown by reference numeral 1 and includes terminal units 2 provided at the user side and a relay unit 2 for generating information to be provided to the user side and transmitting it to the terminal units 2. In the information provision system 1, the relay unit 3 has an information holding function unit 4 for holding, as information to be provided to the user side, basic information I1 fixed for users as a whole and individual user customizable additional information I2 to be added to this basic information I1. The information I1 and I2 are stored in a basic information database 15 and an additional information database 16.

Further, each terminal unit 2 has an additional command transmitting function unit 11 for transmitting an information addition command CM (command) for instructing the above additional information I2 in accordance with user requests to the relay unit 3.

The relay unit 3 is provided with an information processing function unit 13 for obtaining additional information I2 corresponding to the received information addition command CM and adding it to the basic information I1 and transmits the processed information I3 after the addition to the terminal unit 2.

Here, to facilitate understanding, giving general examples of the basic information I1 and the additional information I2, the basic information I1 is map information in a navigation system while the additional information I2 is information on facilities such as convenience stores, restaurants, and amusement parks. If the above information addition command CM is for “restaurants”, the processed information I3 combining the information I1 and information I2 displays on the display unit of the car navigation system names of candidates (one or more) of destination restaurants as landmarks superposed over the map (I1) of the surroundings.

Examining the terminal units 2 and relay unit 3 forming the information provision system 1 separately, the following (i) and (ii) may be said:

(i) Each terminal unit 2 is provided at the user side and receives information to be provided to the user side from the relay unit 3 producing it. The terminal unit 2 is provided with an addition command transmitting function unit 11 for transmitting an information addition command CM for instructing additional information I2 in accordance with a user request to the relay unit 3 holding basic information I1 fixed for the users as a whole and individual user customizable additional information I2 to be added to the basic information I1 and a processed information receiving function unit 12 for receiving processed information I3 from the relay unit 3 performing processing for adding the additional information I2 corresponding to the information addition command CM to the basic information I1.

(ii) The relay unit 3 generates information to be provided to the user side and transmits it to the user side terminal units 2. The relay unit 3 is provided with an information holding function unit 4 for holding, as the information to be provided to the user side, basic information I1 fixed for the users as a whole and individual user customizable additional information I2 to be added to the basic information I1; an information processing function unit 13 for receiving an information addition command CM for instructing additional information I2 in accordance with a user request, obtaining the additional information I2 corresponding to the information addition command CM, and adding it to the basic information I1; and a processed information transmitting function unit for transmitting the processed information I3 after the addition to a terminal unit 2.

Conventional car-mounted terminal units were able to receive outside information from television, radio, and other broadcasting systems. This was a one-way flow of information from the broadcasting side. As opposed to this, according to the present invention, it is possible to make the car-mounted terminal unit an information terminal unit connectable with the Internet and thereby possible to construct a server-linked system.

Further, in this server-linked system, it is possible to process service information (the above processed information I3) in accordance with requests from the car-mounted terminal unit side (the above information addition command CM). Due to this, it becomes possible not only to provide information one-way from the broadcasting station, but also to transfer information between the server and a terminal unit and provide only the information desired by the user side on-demand.

This means the provision of service limited only to the information required matching user preferences and simultaneously eliminates the above-mentioned problem of increased communication costs.

The present invention will be explained in more detail below.

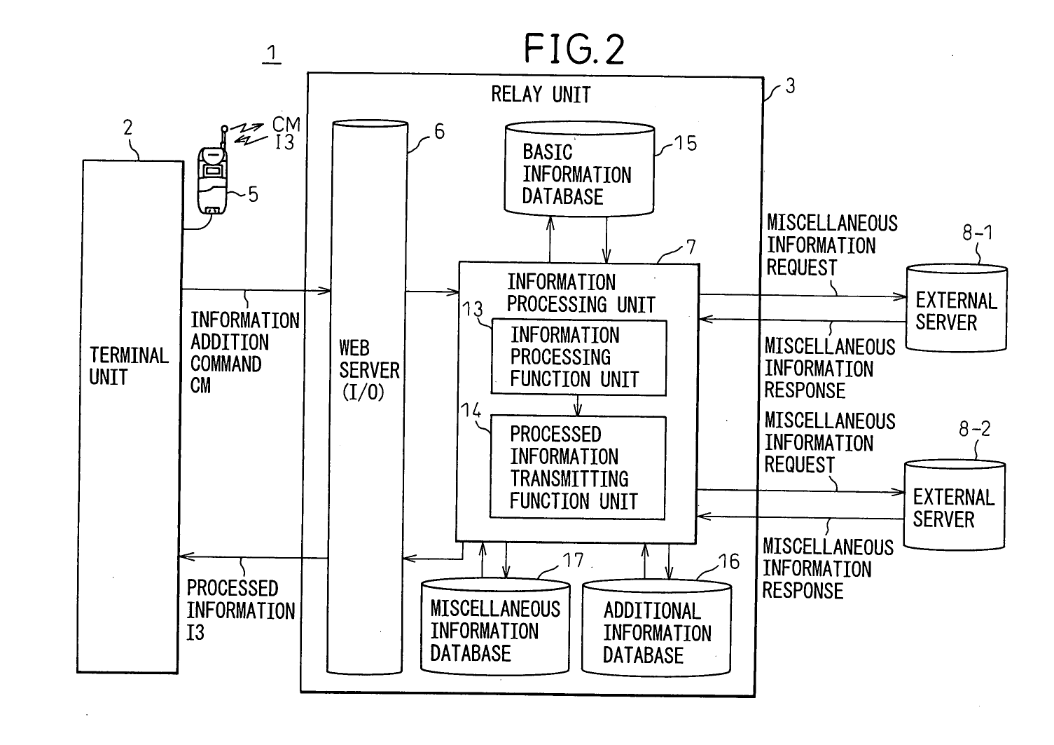

FIG. 2 is a view of an example showing the basic configuration of FIG. 1 in somewhat more detail. Note that throughout the figures, similar constituent elements are assigned the same reference numerals or symbols.

The constituent elements newly shown in FIG. 2 are a mobile phone 5, Web server 6, information processing unit 7, external servers 8-1 and 8-2, and a miscellaneous information database 17.

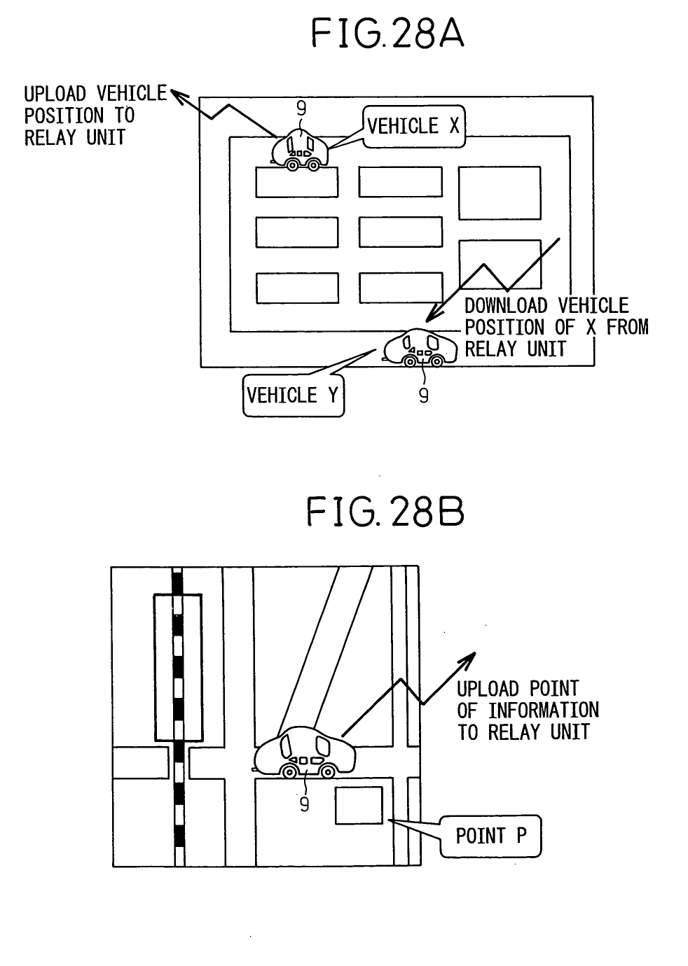

A mobile phone 5 and Web server (I/O) 6 are connected between the terminal unit 2 and the relay unit 3. For example, a general Internet service provider (ISP) and Internet network (for example, the IP shown in FIG. 27) are interposed between the mobile phone 5 and the server 6.

The Web server 6 is further connected to the information processing unit 7 forming the heart of the relay unit 3. This information processing unit 7 includes at least the above-mentioned information processing function unit 13 and processed information transmitting function unit 14 and operates cooperatively with the basic information database 15 and additional information database 16. The information processing unit 7 also operates cooperatively with the miscellaneous information database 17. The miscellaneous information database 17 stores terminal information, vehicle information, customer information, charge information, etc. These will be explained later.

The relay unit 3 can further have the above-mentioned external servers 8-1 and 8-2 explained above and linked with the same as information holding function units 4. At least one of these external servers holds the basic information I1, while at least another holds the additional information I2. The basic information I1 and the additional information I2 are diverse and huge. The sources of the information are spread over the entire country, so it is further preferable to link up with various external servers 8-1, 8-2, etc. The relay unit 3 issues a request for obtaining information to the external servers in accordance with need and receives the desired information in the responses.

The different modes of transfer of information between the terminal unit 2 and the relay unit 3 in the information provision system 1 configured in this way are shown below by sequence diagrams.

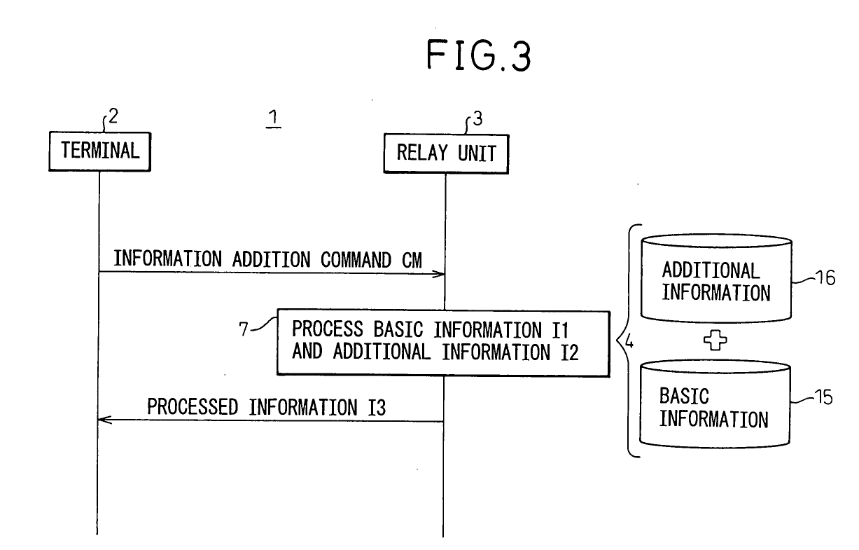

FIG. 3 is a sequence diagram of a first mode of transfer of information in the system 1.

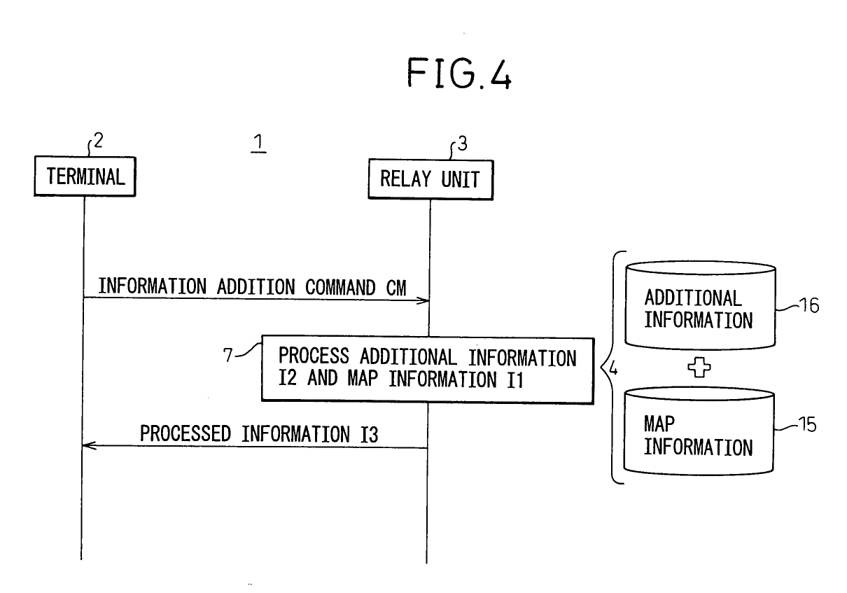

In the figure, reference numeral 2 indicates the above-mentioned terminal unit (expressed as only “terminal” in the figure), 3 indicates the above relay unit, 4 indicates the above information holding function unit, 7 indicates the above information processing unit, indicates the above basic information database, and 16 indicates the above additional information database (same in FIG. 4 to FIG. 15).

First, the user notifies a portal server constituted by the relay unit 3 of the additional information which it desires by the information addition command CM from the terminal unit 2.

Receiving this, the relay unit 3 obtains the basic information I1 to be provided from the basic information database 15 and obtains the additional information I2 to be added to the basic information I1 corresponding to the information addition command CM from the additional information database 16.

The information I1 and 12 obtained here are processed at the information processing unit 7, whereupon the processed information I3 (=I1+I2) is returned to the user.

FIG. 4 is a sequence diagram of a second mode of transfer of information in the system 1.

In this second mode, the basic information I1 is map information, while the additional information I2 in accordance with the information addition command CM is information to be displayed on the display unit at the terminal unit 2 superposed over the map formed by the map information. Due to this, extraneous information to the user can be eliminated.

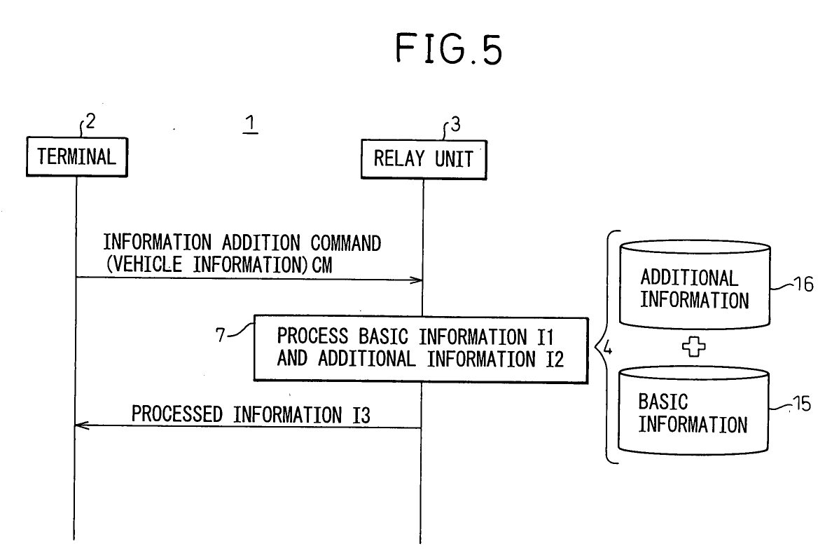

FIG. 5 is a sequence diagram of a third mode of transfer of information in the system 1.

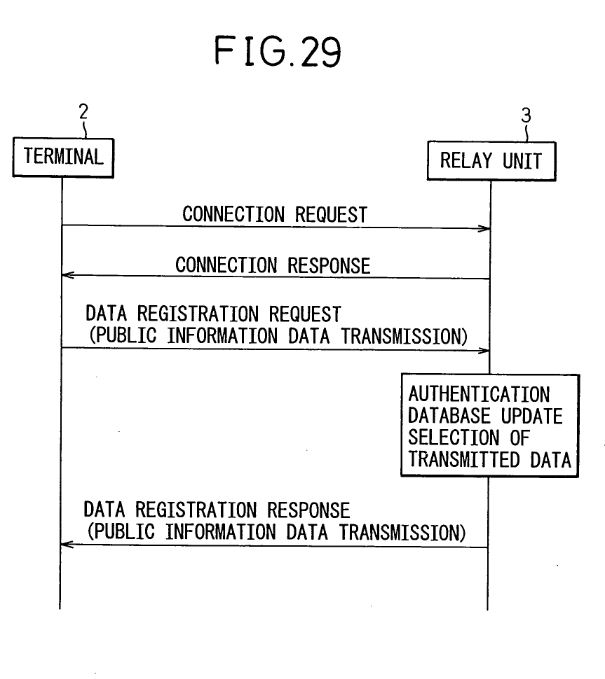

In this mode, the terminal unit 2 is a car-mounted terminal unit (in the figure, labeled as “car-mounted terminal”). Here, the basic information I1 is map information. When the information addition command CM is for vehicle information relating to the vehicle 9 (FIG. 28), the processed information I3 from the relay unit 3 is map information matching with that vehicle information.

The vehicle information, for example, may be type information indicating if the vehicle 9 is a large sized, medium sized, or small sized vehicle. Further, if the information addition command CM indicates “large sized”, the processed information I3 becomes map information only for roads where the vehicle can clear width restrictions or height restrictions.

Therefore, information matched with the status of the vehicle can be obtained.

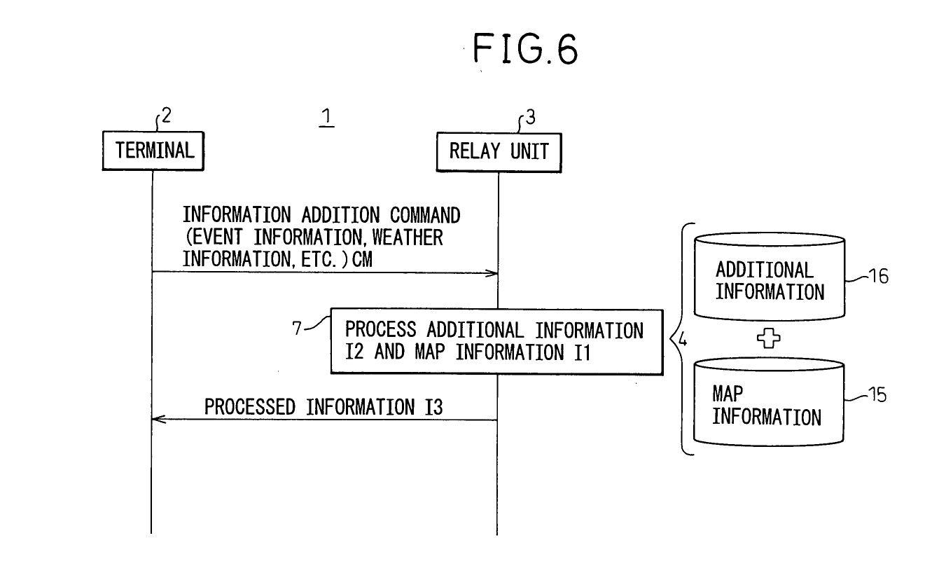

FIG. 6 is a sequence diagram of a fourth mode of transfer of information in the system 1.

In this mode, information to be displayed on the display unit superposed on a map formed by map information is real time information valid only from the current point of time to a point of time after the elapse of a predetermined time period.

“Real time information” is information with a real time property. As a representative example, event information, weather information, etc. may be mentioned. In addition, vehicle congestion information, department store sale information, festival information, etc. may be mentioned. Whatever the case, information which loses all meaning after that time passes is real time information.

This is truly a mode in which the effect of the server-linked system utilizing the Internet can be exhibited in full.

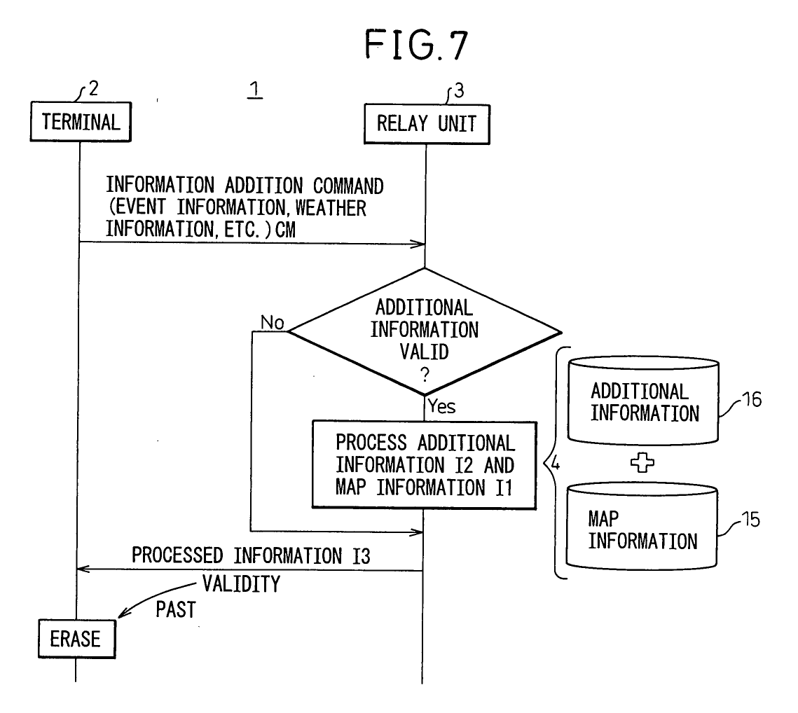

FIG. 7 is a sequence diagram of a fifth mode of transfer of information in the system 1.

This mode is paired with the fourth mode. The relay unit 3 further adds validity data to the real time information for transmission, while the terminal unit 2 erases the real time information it receives and holds in accordance with that validity data.

This is so as to maintain the real time property.

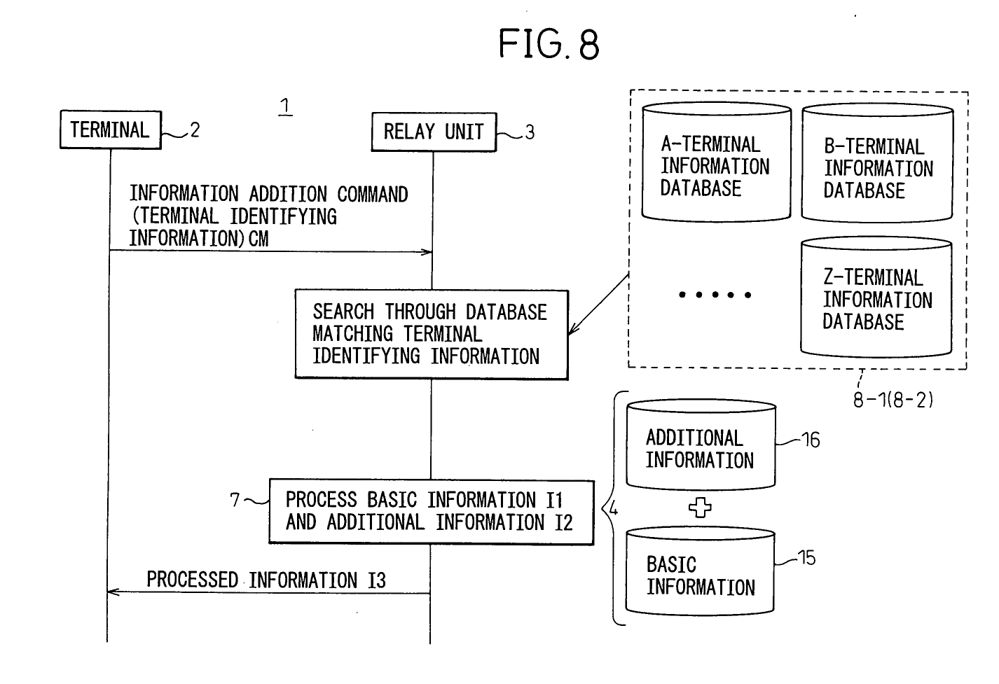

FIG. 8 is a sequence diagram of a sixth mode of transfer of information in the system 1.

In this embodiment, the terminal unit 2 transmits terminal identifying information indicating itself as an information addition command CM to the relay unit 3. The relay unit 3 receives this terminal identifying information, generates processed information 13 matching the terminal attributes corresponding to this, and transmits it to the terminal unit 2.

An example where this mode is advantageous is explained next.

For example, the external server 8-1 (8-2) stores terminal information of the user A, user B. user z owning terminal units 2. One example of this terminal information is the screen size of the display unit in the car navigation system owned by each user, for example, the user A has a large screen, the user B has a small screen.

If assuming now that the user B uses the terminal unit 2 to request map information from the relay unit 3 including an information addition command CM, the relay unit 3 obtains the terminal identifying information of the user B from the information addition command CM and searches through the B-terminal information database corresponding to this. This being the case, it learns that the display screen in the navigation system of the user B is a small screen, so the relay unit 3 processes the map information to be sent to the terminal unit 2 of the user B to reduce the amount of information, then sends the processed result.

It is therefore possible to eliminate the waste of sending a large volume of precise map information to a small screen display unit.

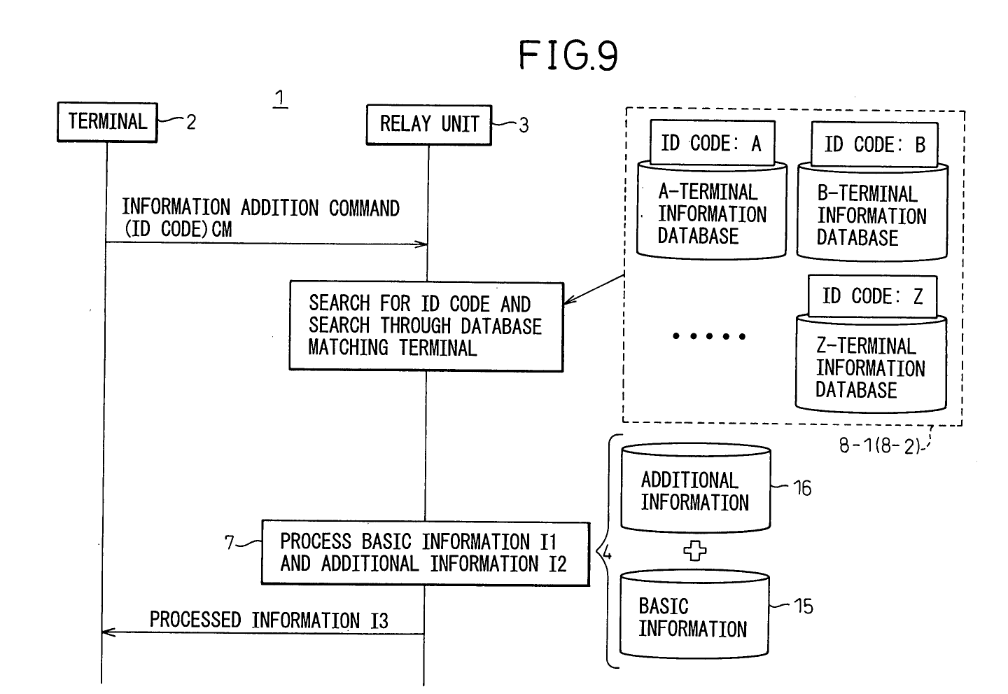

FIG. 9 is a sequence diagram of a seventh mode of transfer of information in the system 1.

This mode is one where the terminal identifying information is an ID code assigned to the terminal unit 2. Further, the relay unit 3 holds the above terminal attributes corresponding to the ID code.

The terminal attribute may be the screen size of the display unit, the number of pixels, the version of the HTML document displayed on the screen, etc.

According to this mode, by employing the ID code, it is possible to reduce the amount of data between the terminal unit 2 and the relay unit 3. This leads to a suppression of the communication costs.

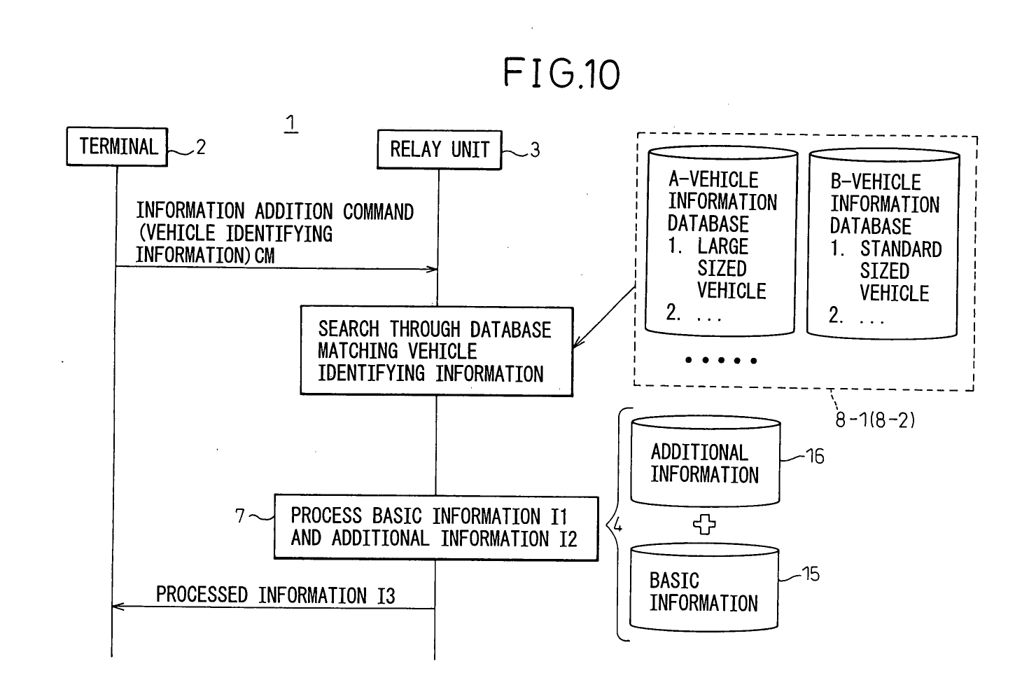

FIG. 10 is a sequence diagram of an eighth mode of transfer of information in the system 1.

In this mode, the terminal unit 2 is a car-mounted terminal unit. Further, when the basic information I1 is the map information and the above terminal attribute is vehicle information relating to the vehicle 9, the processed information I3 to be transmitted from the relay unit 3 to the terminal unit 2 is made map information matched with the vehicle information.

Giving one example, assume that the vehicle information is a description to the effect that the vehicle is a “large sized vehicle”. Further, assume that there is a request for provision of information from the user A regarding the “parking lots” around a destination area. If so, as the processed information I3, map information eliminating all parking lots not allowing large sized vehicles is provided. Further, as another example, when driving at night, it is possible to provide route guidance eliminating roads not allowing passage of large sized vehicles at night by the processed information I3.

Accordingly, it is possible to select and provide only information matching with the vehicle of the user and in turn reduce the communication costs.

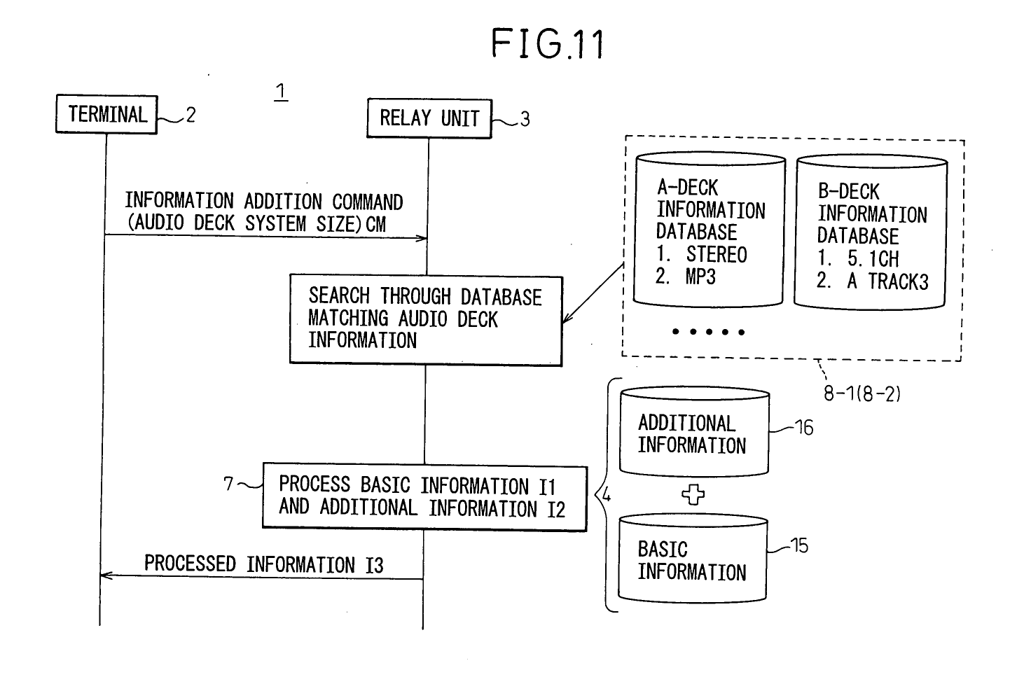

FIG. 11 is a sequence diagram of a ninth mode of transfer of information in the system 1.

In this mode, when the terminal attribute is information showing the size and performance of an audio deck connected to the terminal unit 2, the processed information I3 from the relay unit 3 is made audio information matched with the size and performance of the audio deck.

For example, when delivery (downloading) of certain music is requested by the user A, according to the configuration shown in FIG. 1, since the audio deck owned by the user A is a stereo system, it is sufficient that the music to be delivered be of a stereo specification. Delivery for example of a 5.1 ch specification audio source suitable for the user B would be meaningless.

Therefore, it is possible to provide an audio source corresponding to the hardware specifications of the user's system.

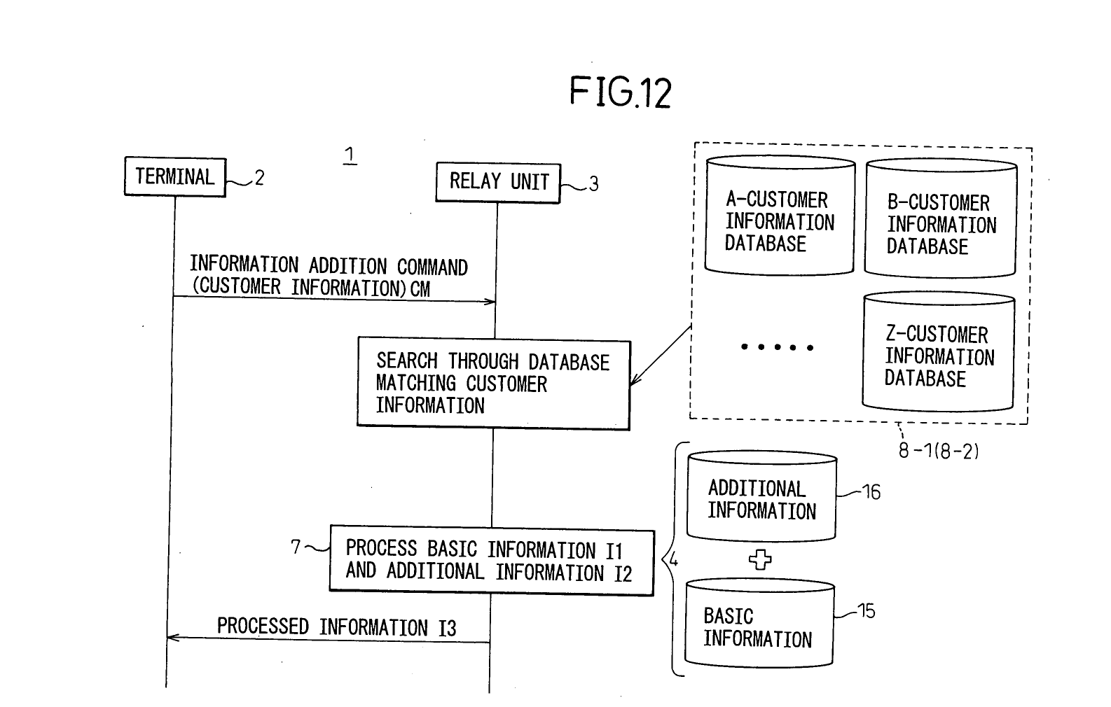

FIG. 12 is a sequence diagram of a 10th mode of transfer of information in the system 1.

In this mode, when the terminal attribute is preference information of the terminal unit 2 side user, the processed information I3 to be transmitted from the relay unit 3 to the terminal unit 2 is made media delivery information matched with the preference information.

This “preference information” includes for example preferences relating to movies, music, news, sports, etc. Further, even looking at just music, there are jazz, pops, live music, Japanese songs, etc. These all constitute customer information.

For example, if a user A who likes jazz designates “media delivery”, in particular, “music delivery”, as the information addition command CM, an audio source selected from the preferred jazz genre is provided.

Therefore, it is possible to provide media matching the preference of the customer at all times.

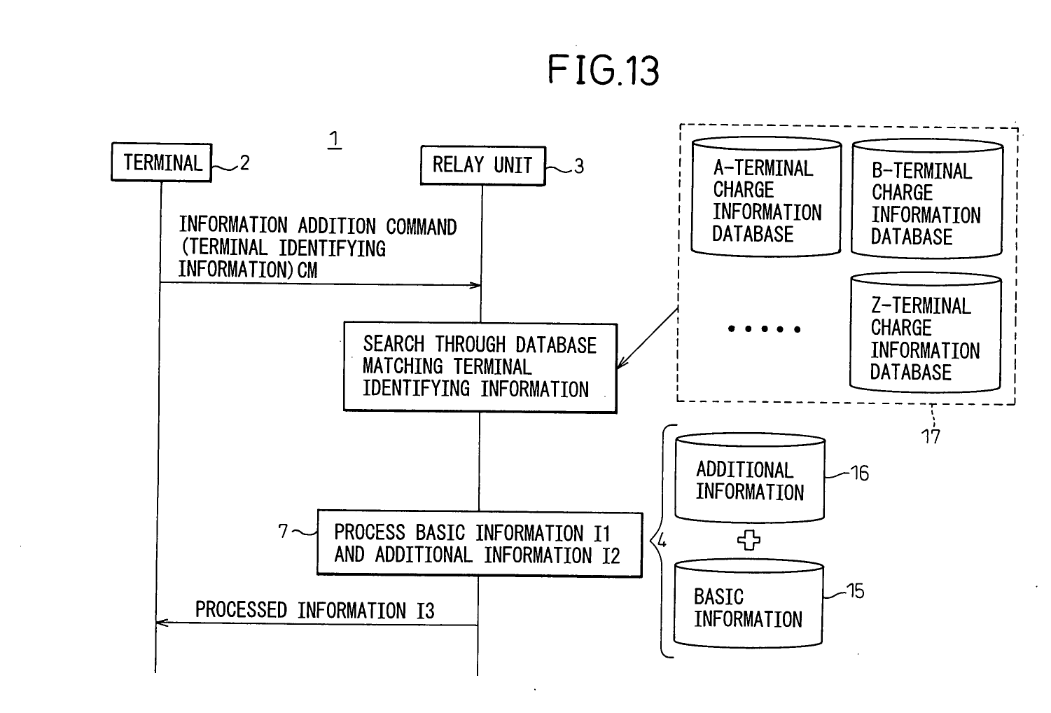

FIG. 13 is a sequence diagram of an 11th mode of transfer of information in the system 1.

According to this mode, the relay unit 3 is provided with a charge information holding function unit for adding up and holding charge information corresponding to the terminal identifying information. Further, each time processed information I3 is sent for each terminal identifying information, the charge information is added at the relay unit 3 side. Note that this charge information holding function unit can be realized by the miscellaneous information database 17 shown in FIG. 2.

Referring to FIG. 2, there is a service charge which the relay unit 3 assesses on the user of the terminal unit 2 side and a communication charge to be paid to the carrier for communications performed by the mobile phone 5 dedicated to the terminal unit 2 and the relay unit 3. If this communication charge is a flat rate, the user itself receiving the information provision service according to the present invention (one of a plurality of persons) should pay an amount corresponding to the provision service.

At this time, if having the charge processing for each user as identified by for example a password performed automatically at the relay unit 3 side, each user can receive a user friendly information provision service without being bothered with calculating its own charges.

Finally, a 12th mode and 13th mode will be briefly explained. More detailed explanations will be given from FIG. 28 on.

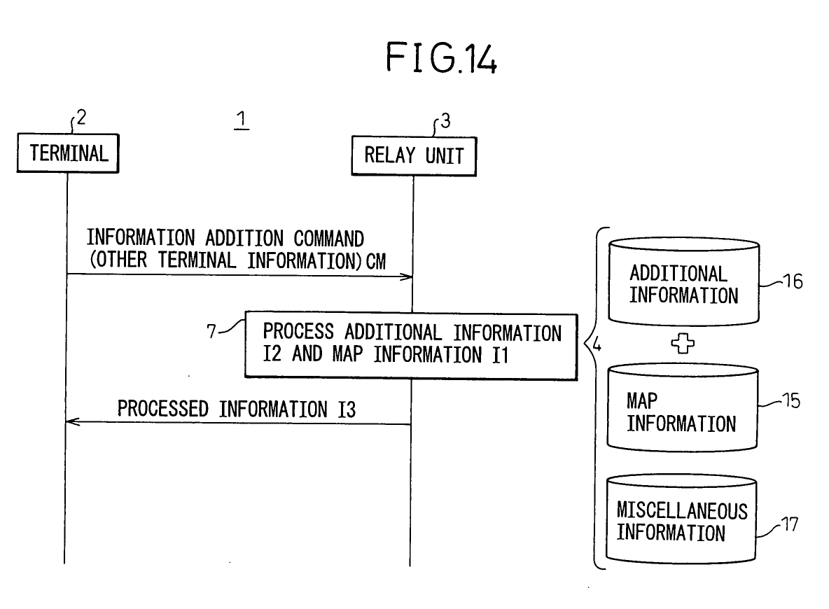

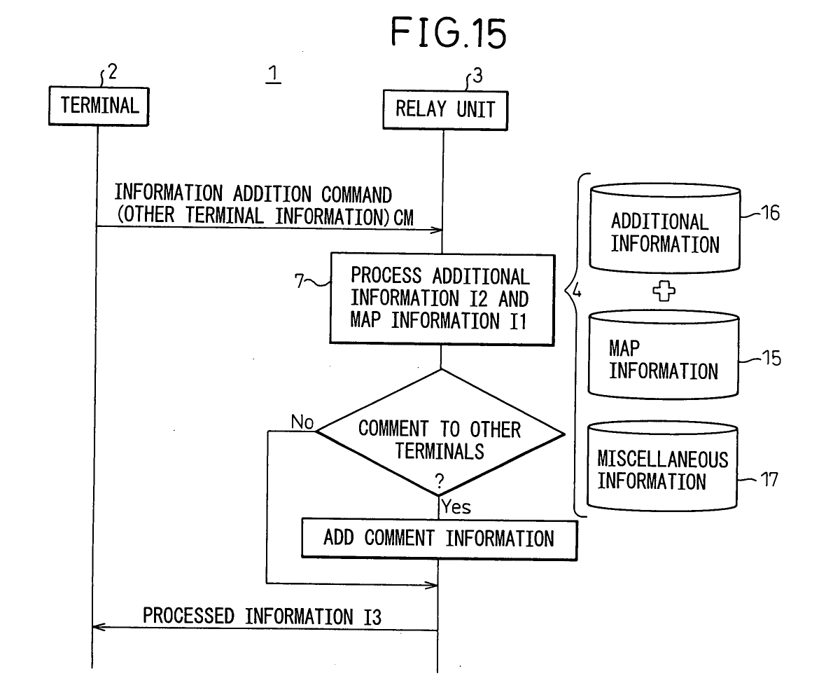

FIG. 14 is a sequence diagram of a 12th mode of transfer of information in the system 1, and FIG. 15 is a sequence diagram of a 13th mode of transfer of information in the system 1.

These 12th and 13th modes are ones in which the additional information I2 according to the information addition command CM is terminal originated information transmitted freely from any terminal unit 2. The basic information in this case may be of any type, but optimally is the above-mentioned map information.

Note that a terminal originated information holding function unit is necessary for holding the terminal originated information corresponding to the different terminal units 2, but this function unit can be realized by the miscellaneous information database 17 shown in FIG. 2.

As a specific example of the 12th mode (FIG. 14), it is possible to mention the case where a plurality of users create a group and go out for a drive. In this case, if each user uploads its own POI at the relay unit 3, it is possible to learn the positions of the other users in the group from marks displayed on the map.

Further, as a specific example of the 13th mode (FIG. 15), in the above case, the users in the group can circulate any comments as terminal originated information to the other users in the group. For example, this can be applied to the case where the leader class user in the group sends instructions to all members of the group with comments on the next meeting place. If the relay unit 3 receives such a comment, it stores this comment information in the above database 17.

Assume that each user in the group occasionally checks to see if there are comments from other users at the relay unit 3.

Such comments are preferably nonpublic information since being comments in the group, but do not necessarily have to be limited to within the group. For example, it is also possible for all users provided with terminal units 2 able to join the information provision system 1 according to the present invention to provide terminal originated information to all other users and for all other users to view this. The comments at this time are public information. For example, if a traffic accident occurs in front of the eyes of one user, since traffic would be restricted near the site of the accident, if it comments on this and uploads this to the relay unit 3 along with the POI of the site of the accident, all of the other users could learn of this fact and if necessary select routes bypassing this location.

At this time, the system 1 may also be configured so as to notify all of the users of detours as navigation information.

In the above sequence diagrams, single relay units 3 were shown, but with a single relay unit 3, the information provision system 1 would be considerably short of capacity if a large number of users connected together like in the 12th and 13th modes.

Therefore, it is necessary to use the relay unit 3 as a main server and add at least one sub server and link them up. In the above-mentioned FIG. 2, in view of this situation, two sub servers 2 are shown. These are the external servers 8-1 and 8-2.

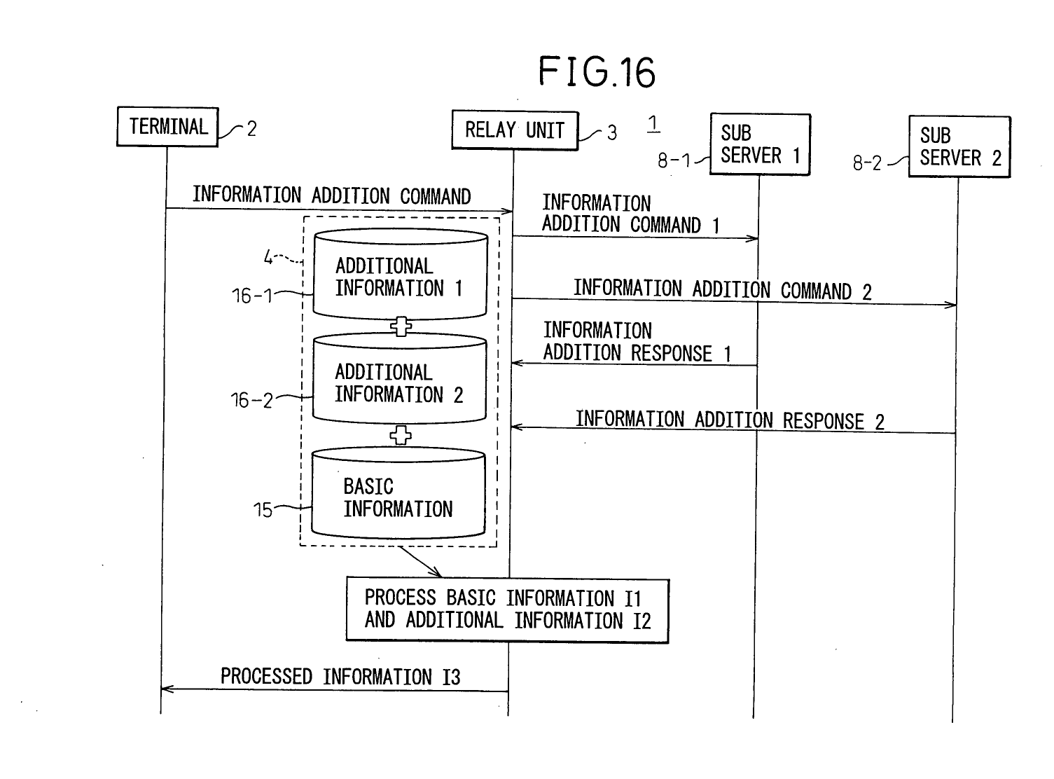

FIG. 16 is a sequence diagram in the case of constructing the system 1 by a plurality of servers.

In this sequence diagram, compared with the sequence diagrams up to here, the first sub server (external server) 8-1 and the second sub server (external server) 8-2 are newly added. Further, corresponding to this, the additional information databases 16-1 and 16-2 are provided.

Here, the information request and the information response for the external server 8-1 in FIG. 2 are shown as the information addition command 1 and the information addition response 1. Further, the information request and the information response for the external server 8-2 in FIG. 2 are shown as the information addition command 2 and the information addition response 2.

Next, the case of application of the second mode (FIG. 4) and the fourth mode (FIG. 6) to the configuration of FIG. 16 will be shown.

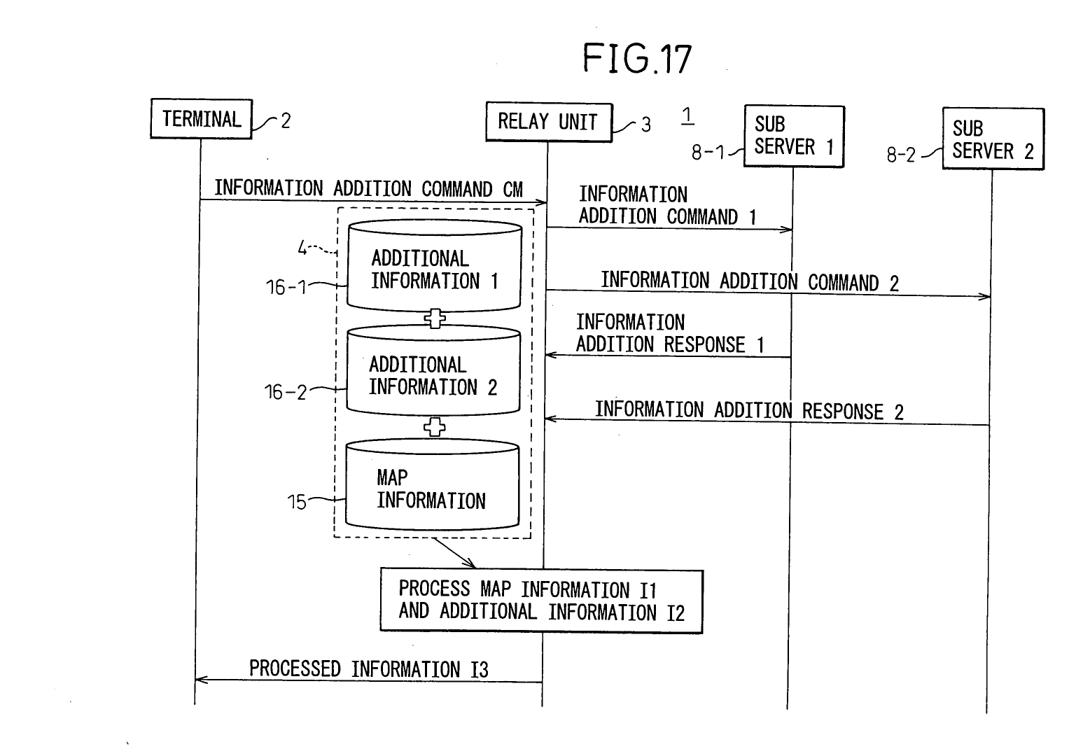

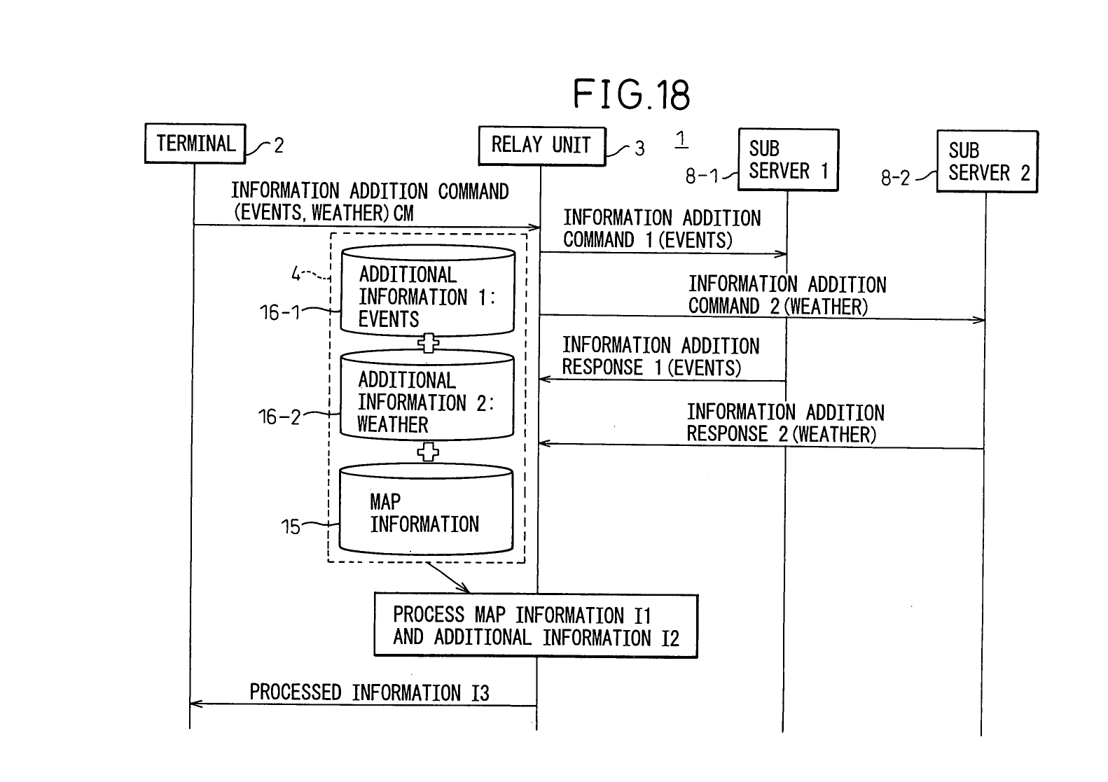

FIG. 17 is a sequence diagram of the case of application of the second mode (FIG. 4) to FIG. 16, while FIG. 18 is a sequence diagram of the case of application of the fourth mode (FIG. 6) to FIG. 16.

In FIG. 17, the case of making the basic information I1 map information is shown. This is meant for construction of a car navigation system.

FIG. 18 also is meant for construction of a car navigation system, but makes the additional information 12 real time information (even information or weather information). In this case, the sub server 8-1 has a real time event information database, while the sub server 8-2 has a real time weather information database.

In the above modes, the central role is played by the relay unit 3. In particular, the information processing unit 7 (FIG. 2) is important. Therefore, an example of operation of the present invention will be explained focusing on the information processing unit 7.

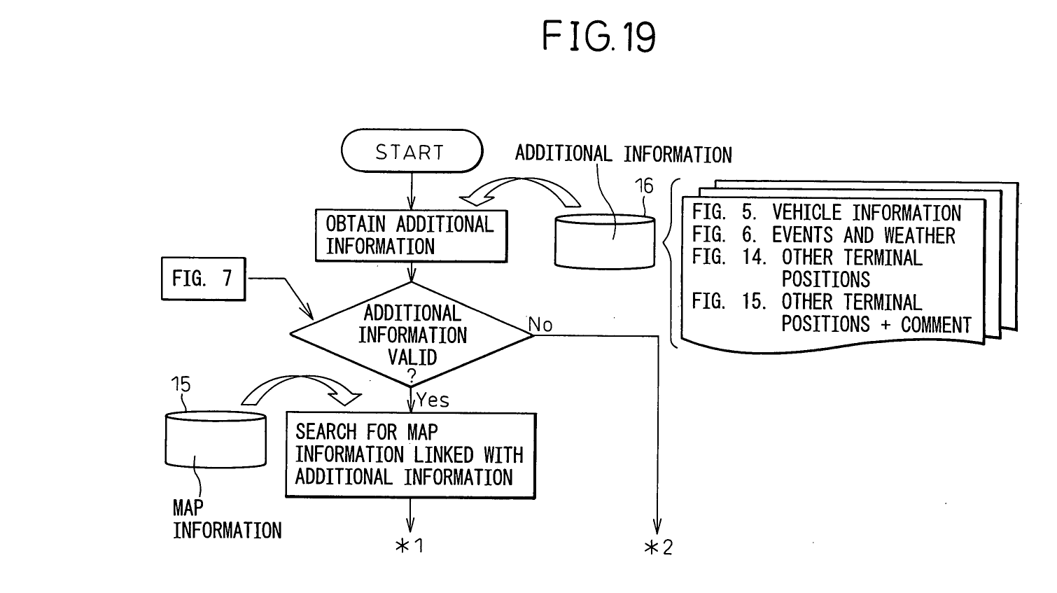

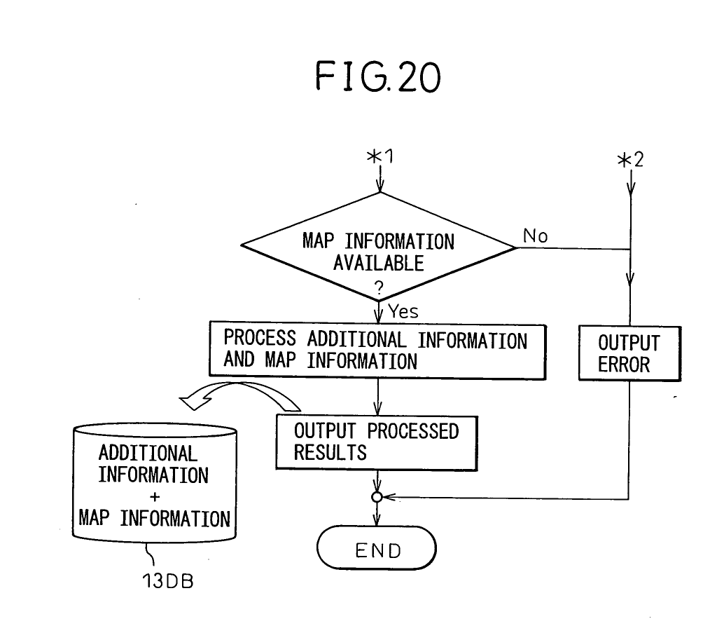

FIG. 19 and FIG. 20 are first and second parts of a flow chart of the operation in the case of the modes shown in FIGS. 5, 6, 7, 14, and 15.

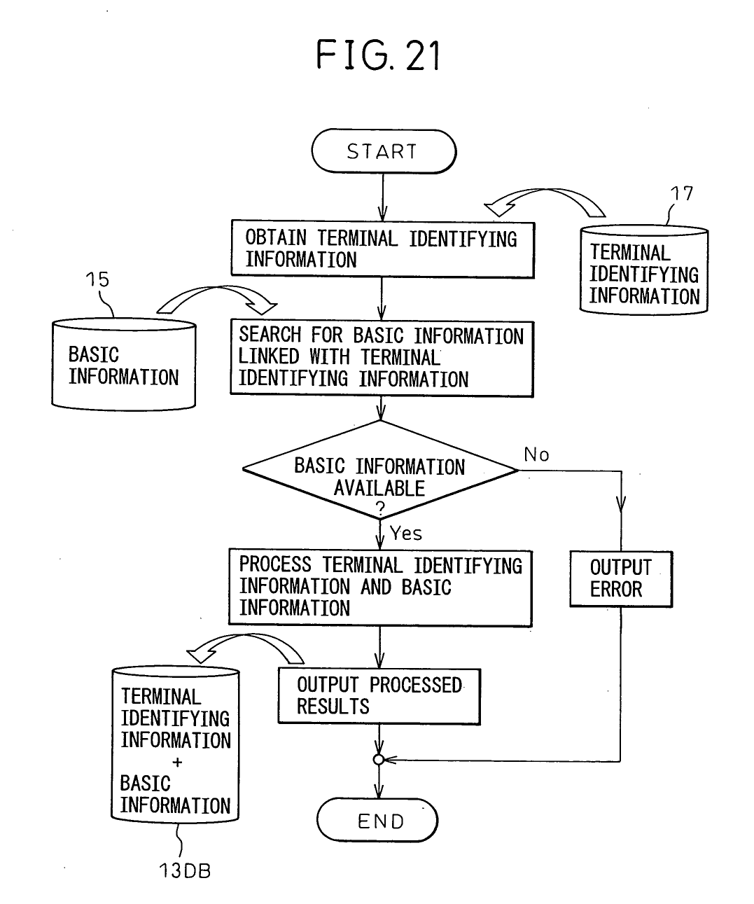

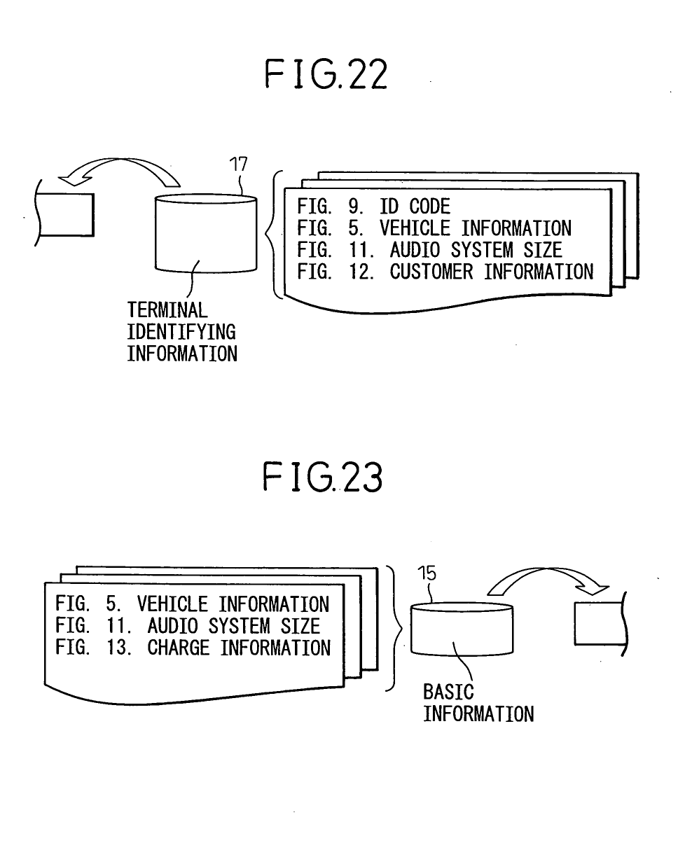

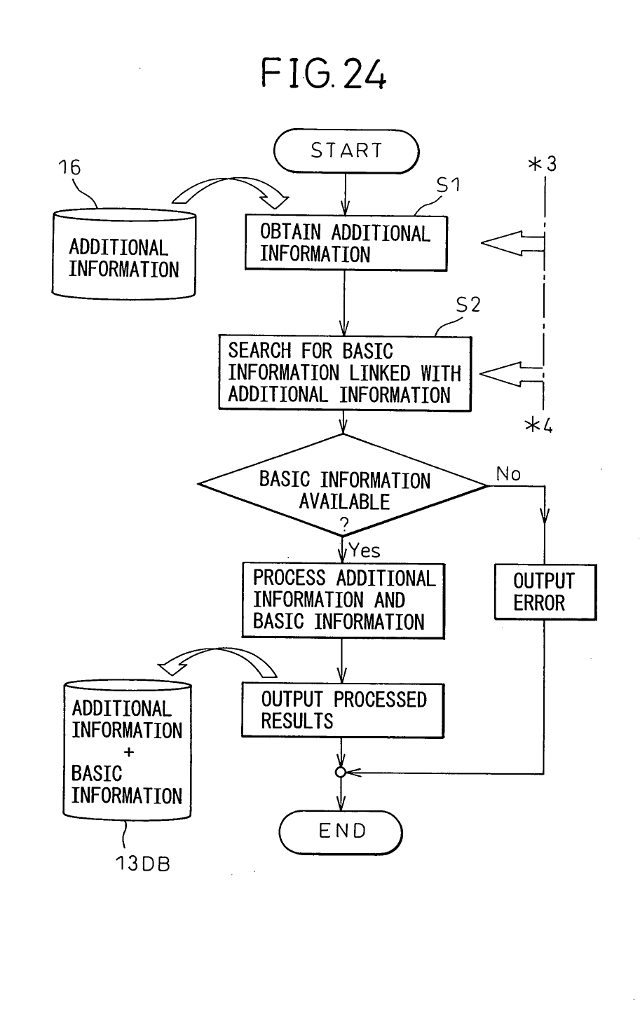

FIG. 21, FIG. 22, and FIG. 23 are first, second, and third parts of a flow chart of the operation in the case of the modes shown in FIGS. 5, 9, 11, 12, and 13.

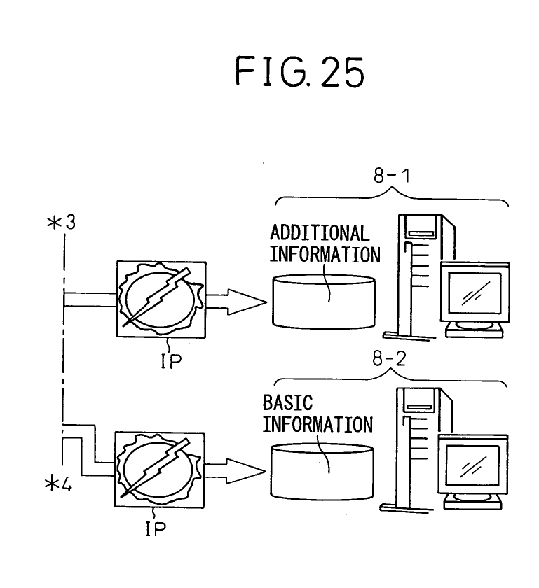

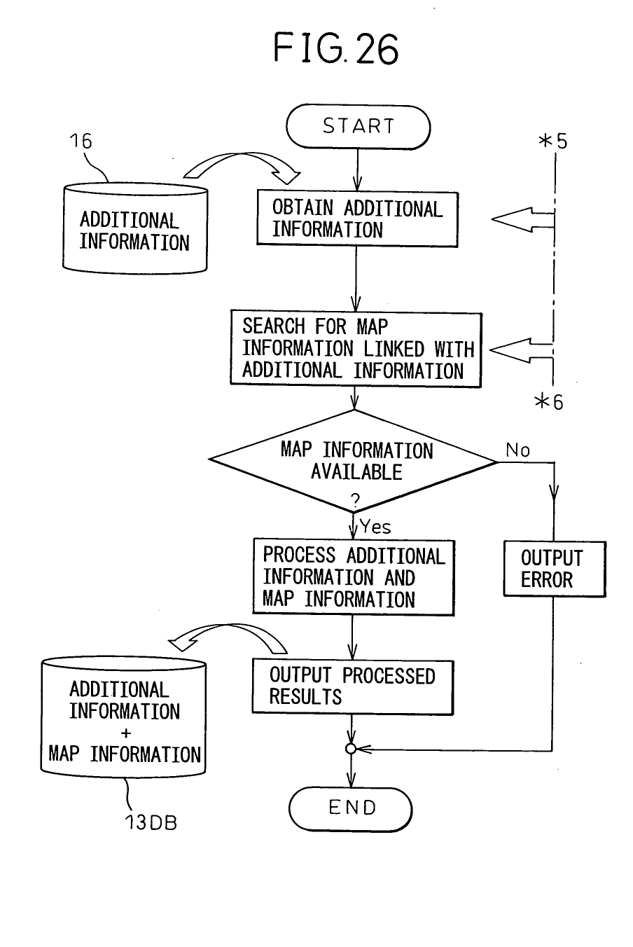

FIG. 24 and FIG. 25 are first and second parts of a flow chart of the operation in the case of the modes shown in FIGS. 16 and 17.

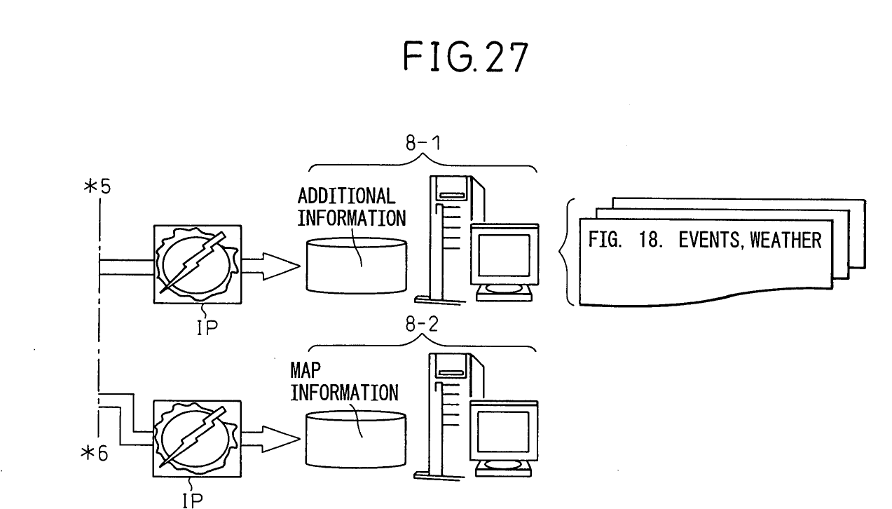

FIG. 26 and FIG. 27 are first and second parts of a flow chart of the operation in the case of the mode shown in FIG. 18.

First, referring to FIG. 19 and FIG. 20, the information processing unit 7 first acquires the additional information. This additional information I2 is acquired from the additional information database 16 (FIG. 2). In the flow of operations shown in FIG. 19 and FIG. 20, one of the following information is acquired from the additional information database 16.

That is, vehicle information (case of FIG. 5), event information/weather information (case of FIG. 6), other terminal position information (case of FIG. 14), and other terminal position information+comment information (case of FIG. 15).

After acquiring the additional information, in the case of FIG. 7, it is judged if the additional information is valid.

If outside its term of validity, “error” is output (FIG. 20) and the processing of the information is ended. If within its term of validity, map information associated with the additional information is searched for. At this time, the map information is searched for from the basic information database 15.

Referring to FIG. 20, if the result of the search is that there is no corresponding map information, “error” is output and the processing of the information is ended. If there is map information, the additional information and map information are processed. For example, if the CM requests events, the data is processed so as to display currently on-going festivals, stores with sales going on, etc. as landmarks.

Therefore, when the processing is ended, the processing results are output and stored once in the database 13 in the information processing function unit 13 (FIG. 2). After this, the processing information transmitting function unit 14 sets up a communication path with the corresponding terminal unit 2 and provides the user with the requested information.

A flow of operations similar to the flow of operations of FIG. 19 and FIG. 20 is performed for FIGS. 21, 22, and 23.

Note that FIG. 22 shows specifically the content of the terminal identifying information database (miscellaneous information database) 17) in FIG. 21, while FIG. 23 shows specifically the content of the basic information database 15 in FIG. 21.

A flow of operations similar to the flow of operations of FIG. 19 and FIG. 23 is performed for FIGS. 24 to 27.

Note that FIG. 25 shows the acquisition (S1) and search (S2) in FIG. 24 performed linked with the external servers (sub servers) 8-1 and 8-2 through the Internet IP. The same is true for FIG. 27 linked with FIG. 26.

FIG. 14 and FIG. 15 simply explain the 12th mode and 13th mode. The 12th and 13th modes will be explained in a little more detail.

If once again noting the main points of the 12th and 13th modes, these modes are characterized in that the additional information I2 corresponding to the information addition command CM is terminal originated information originated from any terminal unit 2. Behind this is the fact that optimally it is assumed that a plurality of users form a group with their own cars and go out for business or leisure.

Under this situation, assume that a plurality of users in the group have to find out about each other's situation or that one user in the group wants to inform all of the other users of a certain matter. In this case, in the prior art, the only method was for the users to talk with each other directly or for example using mobile phones etc. This method needless to say is inconvenient and not desirable in terms of driving safety of the cars.

After this, as explained above, communication-type car navigation systems began to spread and the performance of car-mounted communication terminals became considerably advanced. Even if each user of the group is equipped with such an advanced communication terminal, however, the above problem of the related art still cannot be solved. The reason is that such a communication-type car navigation system only allows one-way provision of information from the center serving as the source of information to the terminal side.

Therefore, if applying the information provision system according to the present invention, information can be easily exchanged among users in the group as with the above 12th and 13th modes. This is because the relay unit 3 can collect information from all of the users in the group and therefore the users can share all sorts of information with each other.

FIGS. 28A and 28B are views illustrating first and second models of terminal originated information.

First, the terminal originated information can be defined overall as follows. Here, assuming that the terminal units 2 are car-mounted terminal units, the terminal originated information includes at least one of the following for types of information:

(1) Positional information of the vehicles 9

(2) Speed information of the vehicles 9

(3) Public report information originated from any terminal unit 2

(4) Nonpublic group shared information circulated only to users in the group when users of a plurality of terminal units 2 form a group

Referring to FIG. 28A, a vehicle 9-X sends its own POI automatically to the relay unit 3 for example each time it runs a predetermined distance. The relay unit 3 registers this information in for example the additional information database 16. While not shown, the same registration is performed for the vehicle 9-Y. This above corresponds to the “positional information of the vehicles 9” of the above definition (1).

Due to this, when the user of the vehicle 9-Y desires to learn the current position of the vehicle 9-X of its associate, it sends an information addition command CM to that effect from the terminal unit 2 of the vehicle 9-Y to the relay unit 3. The relay unit 3 then transmits to the terminal unit 2 of the vehicle 9-Y a map of the surroundings showing the vehicle 9-X as a landmark as the processed information I3. By displaying this on the display unit, the position of the vehicle 9-X on the map can be found in a short time.

The definition (3) or (4) of the terminal originated information can be explained by the model of FIG. 28B.

If a vehicle 9 approaching the point P on the map finds for example that a fire has occurred at the point P, it transmits that fact (event) along with the POI to the relay unit 3.

The relay unit 3 prepares processed information 13 comprised of the map surrounding the point P with the word “FIRE” superposed as a landmark and stores it once in the database 13 (see FIG. 24 etc.) This information corresponds to the “public report information” of the above definition (3).

Therefore, all users belonging to the information provision system 1 can potentially share the above fire (event) information together with the POI. Accordingly, if a user seeking real time event information regarding the point P among all of the users transmits real time information to the relay unit 3 as an information addition command CM, it can learn of that fire. Thus, if setting a suitable detour, it is possible to reach the destination without becoming caught in the congestion resulting from the fire. In this case, the relay unit 3 can also provide that user with that detour as navigation information by the information processing unit 7.

Further, the above public report information is not limited to the example of a fire and may also be information on a specific facility. As such a “specific facility”, there are for example a department store in the middle of a big sale, an amusement park with special performances, etc.

The model of FIG. 28B also applies to communication among users of a group.

For example, assume that while all users of the group are driving during the lunch hour, one user among them happens to find a restaurant perfect for all members of the group to eat at when approaching the point P.

This user immediately uploads this fact to the relay unit 3 along with the POI of the point P. Note that the uploaded information corresponds to the “nonpublic group shared information” of the above definition (4) of the terminal originated information.

Since lunchtime is coming up, the users in the group will access the relay unit 3 looking for some message or another with “acquire shared information” as the information addition command CM. Upon this, the users will download from the relay unit 3 a map of the area around the point P with the restaurant as a landmark and with the comment “let's eat lunch here around 12:30” superposed. All members of the group can then assemble at that restaurant. In this case, since nonpublic information is sought from the relay unit 3, some sort of password is required for the access. However, if receiving the service in the form of a group registration, no password is required.

Additionally explaining the assembling at a restaurant for lunch of the above example, if there are a large number of users in the group, there might be users reaching the restaurant by ordinary roads and users reaching it by highway. In such a case, it is also possible to include speed information of the vehicles of the users as part of the group shared information. This corresponds to the definition (2) of the terminal originated information.

If knowing the speeds of the vehicles, it would be possible to estimate the approximate times of arrival of the users at the restaurant and set a time to enable all members to eat at the same time.

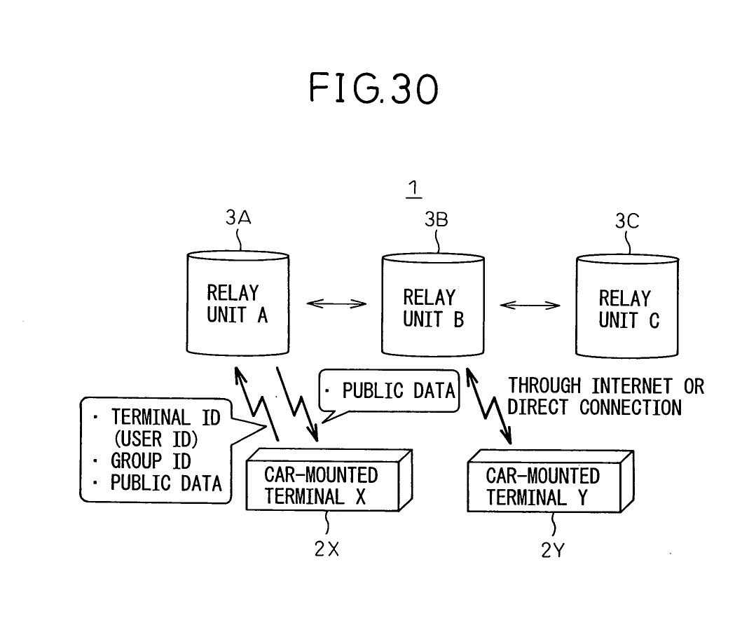

FIG. 29 is a view of an example of the sequence of communication between a terminal unit 2 and the relay unit 3.

Assume that a user in the group requests data registration, for example, requests registration of fire information.

If so, the terminal unit 2 of the user side sends a request for connection of a communication path to the relay unit 3.

Receiving this, the relay unit 3 returns an acknowledgement of connection indicating that it has received the connection request. Only after receiving this response is transmission of the desired data, for example, transmission of public information data, started.

Before the relay unit 3 receives the public information, it first authenticates the received data.

After finishing authenticating it, it newly receives the above public information and updates the additional information database 16 for example.

After finishing updating the database, it selects the data to be transmitted to the other terminal units 2. In the above example, since the transmitted data is public information, it allows it to be circulated to all users upon request. As opposed to this, if the transmitted data is nonpublic information accessible to only the group, certain restrictions are placed on its distribution, such as limiting it to the group.

After this, the relay unit 3 returns to the terminal unit 2 originating the public information a “data registration response” acknowledging the “data registration request” and ends the sequence.

The terminal originated information (1) to (4) explained above can be summarized as follows:

The relay unit 3 can transmit at least one of the four types of information (1) to (4) together with map information showing the position of the vehicle 9 concerned as processed information I3 to a terminal unit 2.

The terminal unit 2 receiving this can display on its display unit the at least one of the four types of information (1) to (4) as a landmark superposed on a map showing the position of the vehicle 9 concerned.

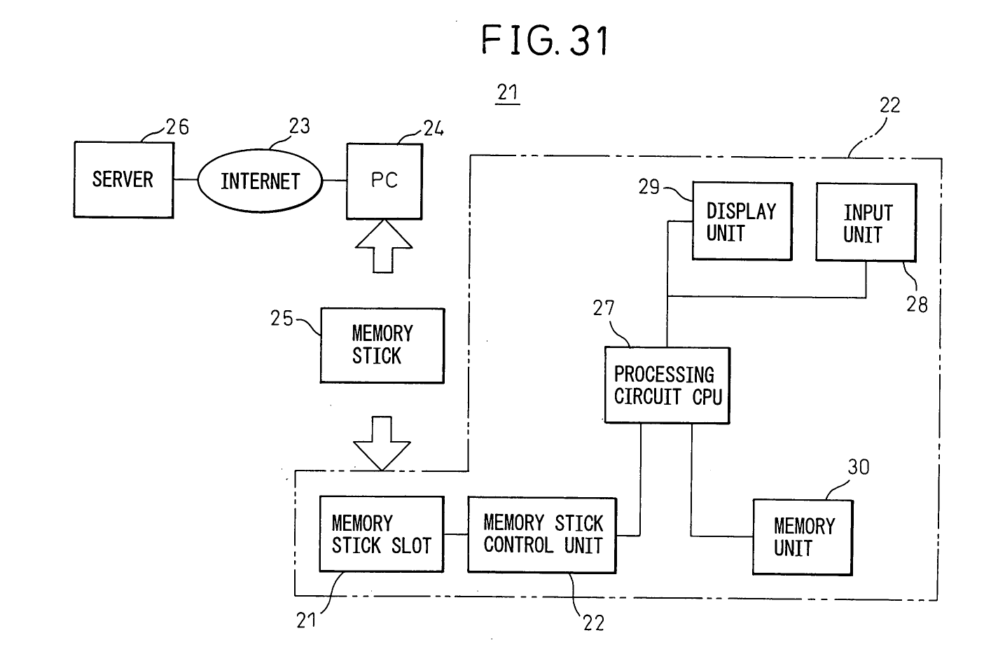

If the size of the terminal originated information becomes huge or the subscribers to the system 1 grow to the entire country, it is anticipated that a single relay unit 3 would no longer be sufficient. This situation is therefore dealt with as shown in FIG. 30.

FIG. 30 is a view of the system configuration showing a modification of a relay unit (server).

As shown in the figure, the relay unit 3 is comprised of a plurality of (in the figure, three) relay units 3A, 3B, and 3C having similar configurations. These plurality of relay units 3A to 3C exchange information and share information. In other words, the load is distributed among the plurality of servers. The relay units 3A to 3C forming the servers can be installed in for example a different region a, region b, and region c.

Finally, the format of the transmitted data transferred from the relay unit 3 to the terminal unit 2 side will be explained a little more.

A terminal unit 2 first has the relay unit 3 register the terminal originated information including terminal identifying information indicating itself and public report information originated by itself.

If the terminal identifying information is for example a nickname and the report information is for example a comment, it gets the relay unit 3 to register the nickname plus the comment.

When the relay unit 3 distributes the registered nickname and comment to the terminal unit 2 side, the information to be distributed becomes a string of alphanumerics etc. with a space at the middle, that is, “nickname”+“ ”+“comment”

Further, the data forming the string of alphanumerics etc. is made the same in form as the data forming the facility information etc. superposed on map information in general and transmitted to the terminal unit 2 side. The “form of data” spoken of here is the usual text data.

By inserting the “ ” in this way, the fact that the information before and after the space is the “nickname” and “comment” can be made clear to the users at the display screen. That is, the difference between the types of information becomes clear.

By standardizing the form of the data as explained above, the application programming interface (API) software processing is made common. Therefore, it is not necessary to deliberately introduce dedicated software processing in order to handle the “nicknames” and “comments” newly introduced according to the present invention either in the relay unit 3 or the terminal units 2 as well.

Summarizing the effects of the invention, as explained in detail above, according to the configuration of FIGS. 1 to 30, in the case for example of a car navigation system, additional information (I2) matching with the request of a user (CM) is added by the processing of the map information (I1) sought by the user, so customized map information (I3) can be acquired by the user.

That is, the minimum required service can be provided and information matching the user preferences or matching the vehicle and having a real time property is processed. In the final analysis, the communication costs can be kept down.

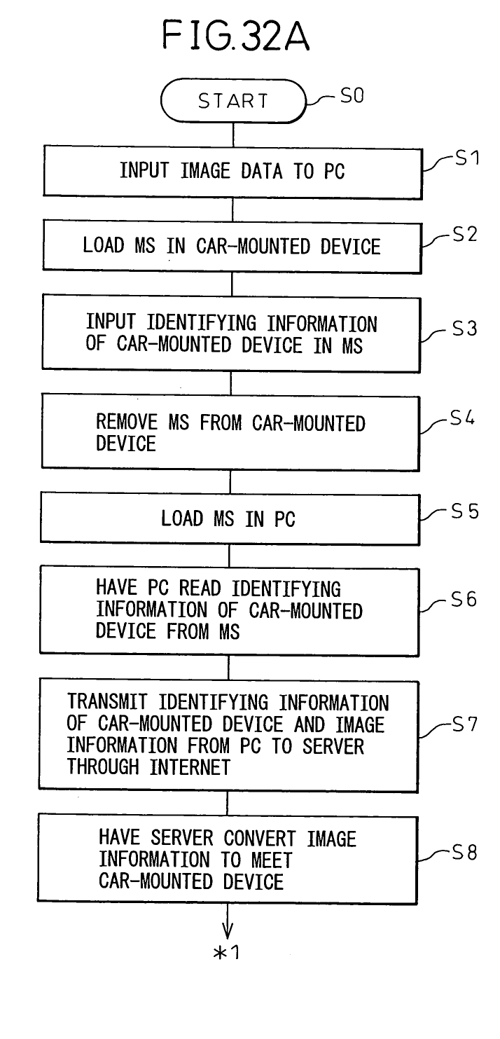

Finally, an example of a modification of the information provision system 1 shown in FIG. 1 to FIG. 30 will be explained with reference to FIG. 31 to FIG. 33. This modification is an image display customizing system. According to the information provision system 1, as explained above, the map information (I1) sought by the user is processed to add additional information (I2) matching with user requests (CM), so it is possible for the user to obtain customized map information (I3).

The image display customizing system shown in FIG. 31 to FIG. 33 enables the seventh mode shown in FIG. 9 to be expanded in scope of customization from still images to moving pictures. This image display customizing system will be explained in detail below.

FIG. 31 to FIG. 33 show the image display customizing system for a car-mounted system using a communication network such as the Internet.

In the past, the means for enjoying moving pictures in image information had been theaters, the television, etc. In each case, the viewer watched the material provided by the distributor or producer in a theater, the home, or other indoor location. In recent years, however, video cameras and moving picture-capable digital cameras have spread in use. The number of people making original moving pictures on their own has grown strikingly. With the appearance of mobile phones able to capture moving pictures and transmit, receive, and play back such captured moving picture information, the number of people enjoying original moving pictures regardless of the location has been increasing even more. Therefore, there are demands for enjoying original moving pictures even when sitting in a vehicle, that is, a motor vehicle, by utilizing car-mounted systems.

Even with car-mounted devices of the related art, however, this demand was never met. In the past, there was a system where a PC was connected to a server through the Internet, image information prepared in advance in the server in accordance with the types of car-mounted devices was extracted by selection of the type of the car-mounted device by the PC, the extracted image information was downloaded to the PC, and the downloaded image information was input to the car-mounted device using for example a memory medium as the transmitting function unit and played back. In this way, the conventional system was limited to the use, that is, play back, of image information prepared in advance in the server for the specific model of the car-mounted device. It was not possible to play back original moving pictures or other image information prepared by the user.

This is because the image size, dot size, and other specifications of image display functions differ for each model of car-mounted device. Therefore, to enable play back of original images prepared by individual users by car-mounted devices, it is necessary for a server to store in advance the original image information prepared by the users to meet the image display specifications of their car-mounted devices linked with model information of all car-mounted devices. Considering the large number of users, however, this is unrealizable in terms of the storage capacity of the server.

Further, in the conventional system, it was possible to select a model of car-mounted device and image information prepared in advance for that model stored in the server from the PC side, but it was not possible for the server side to differentiate and identify the model of the car-mounted device, so the server side could not provide on its own image information processed to meet with the model of a car-mounted device.

As related art concerning obtaining information relating to the operation of a car-mounted device from a server utilizing the Internet, Japanese Unexamined Patent Publication (Kokai) No. 2002-67815 discloses to receive audio deck adjusting data and audio deck mounting data from a center server, have the car-mounted audio system automatically adjust the audio characteristics using the received audio deck adjusting data, and have the user mount the audio deck at the vehicle in accordance with the audio deck mounting data.

However, Japanese Unexamined Patent Publication (Kokai) No. 2002-67815 only discloses deck mounting information and audio information and does not disclose anything regarding image information. Further, it does not touch upon technology enabling a user to play back original image information by a car-mounted device.

FIGS. 31 to 33 show an image display customizing system for a car-mounted device using a communication network enabling any image information to be displayed at a display unit of the car-mounted device regardless of the image display specifications of the car-mounted device.

This image display customizing system comprises a car-mounted device mounted in a vehicle and having a display unit able to display an image, an information communication terminal able to be connected to a communication network and able to send and receive information via that communication network, an information transmitting function unit at least able to transmit identifying information of the car-mounted device from the car-mounted device to the information communication terminal and to transmit image information from the information communication terminal to the car-mounted device, and an image information converting function unit able to be connected to the communication network and able to convert image information received through the communication network to meet with image display specifications of the car-mounted device specified by the identifying information of the car-mounted device received through the communication network and to transmit the converted image information.

Here, the information transmitting function unit may be a portable memory medium which is portable, can be freely attached to the car-mounted device and the information communication terminal, and enables writing and reading of identifying information of the car-mounted device and image information between the car-mounted device and information communication terminal.

Further, the portable memory medium may be a flash memory card.

According to the system shown in FIGS. 31 to 33, the car-mounted device transmits identifying information of the car-mounted device to the information communication terminal, the information communication terminal transmits the identifying information of the car-mounted device and previously input and stored image information to the image information converting function unit through the communication network, the image information converting function unit converts the image information received through the communication network to meet with the image display specifications of the car-mounted device specified by the identifying information of the car-mounted device and transmits the converted information to the information communication terminal, and the information transmitting function unit transmits the converted image information from the information communication terminal to the car-mounted device, so the car-mounted device can display the image information on the display unit.

Accordingly, a user can display original image information individually prepared by a video camera or digital camera at the car-mounted device so as to enjoy the image without the image display specifications of the car-mounted device becoming a problem even when using that original image information as the image information.

Further, according to the system shown in FIG. 31 to FIG. 33, the information transmitting function unit used is a portable memory medium, preferably a flash memory card. By making the information transmitting function unit a portable memory medium separate from the car-mounted device and information communication terminal in this way, a user can store and hold a large amount of image information in portable memory media regardless of the capacity of the memory provided in the car-mounted device. Further, by using a general memory medium like a flash memory card for the portable memory medium, an inexpensive, highly practical system is realized, so the general usefulness of the system is further improved.

FIG. 31 is a block diagram of an example of the configuration of an image display customizing system 21 (corresponding to the information provision system 1 of FIG. 1) for a car-mounted device using a communication network. The image display customizing system 21 for a car-mounted device using a communication network (hereinafter referred to as an “image display customizing system 21”) is comprised of a car-mounted device 22 comprised of an electrical apparatus mounted in a vehicle and having a display unit 29 able to display an image, an information communication terminal 24 able to be connected to a communication network 23 and able to send and receive information through the communication network 23 (similar to function unit 11 and 12 of FIG. 1), an information transmitting function unit 25 at least able to transmit identifying information of the car-mounted device 22 from the car-mounted device 22 to the information communication terminal 24 and transmit image information from the information communication terminal 24 to the car-mounted device 22, that is, a portable memory medium, and an image information converting function unit 26 able to be connected to a communication network 23, convert image information received through the communication network 23 to image display specifications of a car-mounted device 22 specified by identifying information of the car-mounted device 22 received through the communication network 23, and transmit the converted image information (corresponding to the relay unit 3 of FIG. 1).

The car-mounted device 22 is an electrical apparatus mounted in for example a motor vehicle as one example of a vehicle. Specifically, a video deck, an audio deck having a display unit, etc. may be mentioned. The car-mounted device 22 is provided with a processing circuit 27 provided with a central processing unit (CPU) and controlling the operation of the car-mounted device 22 as a whole, an input unit 28 provided with a power switch for the car-mounted device and for inputting operation instruction signals etc., a display unit 29 for displaying image information or the operating state of the car-mounted device 22 etc. in accordance with operation control signals from the processing circuit 27, a memory unit 30 for storing various programs and information, a memory stick slot 31 able to be loaded with the portable memory medium used as the information transmitting function unit 25, that is, a memory stick (one type of flash memory card), and a memory stick control unit 32 for writing and reading information to and from the memory stick 25 loaded in the memory stick slot 31.

The input unit 28 is for example a keyboard provided together with a power switch of a car-mounted device 22 and provided with alphanumeric keys etc. and function keys with predetermined input information. The user of the car-mounted device 22 can depress these keys to input operation instruction signals of the car-mounted device 22. The display unit 29 is realized by for example a liquid crystal display and can display image information and information relating to the operating state of the car-mounted device 22 in accordance with display operation control signals output from the processing circuit 27.

The memory unit 30 is comprised of for example a hard disk drive and enables image information to be written and read at any time. The memory unit 30 stores in advance, at the time of product shipment, a program enabling the processing circuit 27 to control the overall operation of the car-mounted device 22 and identifying information of the car-mounted device 22 such as the product serial number and model name.

In the example of FIG. 31, the information communication terminal 24 is a PC. The information communication terminal 24 can be connected to the Internet 23 and send and receive information with the image information converting function unit 26 and other information communication terminals through the Internet 23. Further, the illustrated PC 24, while not illustrated, like the car-mounted device 22, is provided with a memory stick slot enabling a memory stick 25 to be loaded and a memory stick control unit, so can read and write information from and to a memory stick 25 loaded in the memory stick slot.

In the illustrated example, the image information converting function unit 26 is a service server connected to the Internet 23. The server 26 is provided in advance with an operation control program for converting the input image information to formats meeting the image display specifications of different types of car-mounted devices. Therefore, if the PC 24 inputs the image information and identifying information of the car-mounted device 22, that is, the product serial number or model name, through the Internet 23, the car-mounted device 22 is specified based on this identifying information and the format of the input image information is converted to a format meeting with the image display specifications of the car-mounted device 22. The converted image information is transmitted again through the Internet 23 to the PC 24. Here, the “format of the image information” means the image display size, number of display colors, dot size, etc.

Further, the server 26 can not only convert the format, but also prepare a “slide show” using the image information received as a plurality of still images and transmit this “slide show” as converted image information, that is, convert the received still image information to “slide show” image information meeting the image display specifications of the car-mounted device 22 and transmit the same.

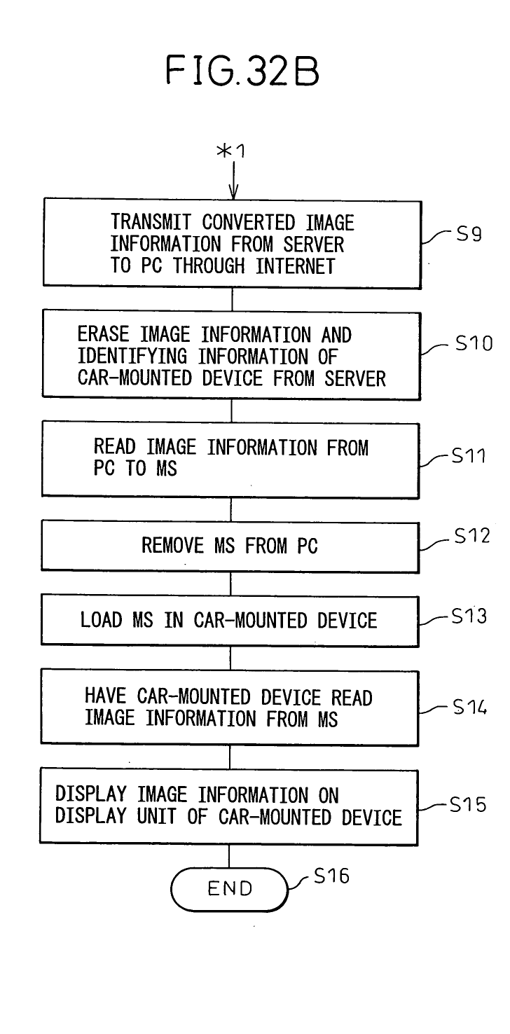

FIGS. 32A and 32B are parts of a flow chart for explaining the conversion of image information and image display of the image display customizing system 21. The conversion of image information and image display in the image display customizing system 21 will be briefly explained with reference to FIGS. 32A and 32B.

At the start of step S0, the car-mounted device 22 and PC 24 are started up, the PC 24 is connected to the Internet 23 to enable communication with the server 26, and the user readies original image information it has prepared itself. Note that this image information may be moving picture information or a plurality of still images.

At step S1, image information is input to the PC 24. This image information is input by the user by a known method. For example, it is possible to input the image information recorded on a compact disk or DVD from drive units for the same provided at the PC 24 or to input image information recorded in a flash memory card through a PC card adapter etc.

At step S2, the memory stick (abbreviated as “MS” in FIG. 32A) 25 is loaded in the memory stick slot 31 of the car-mounted device 22. At step S3, the identifying information of the car-mounted device 22 read from the memory unit 30 is written into the memory stick. At step S4, the memory stick 25 is removed from the car-mounted device 22.

At step S5, the memory stick 25 is loaded in the PC 24. At step S6, the PC 24 reads out the identifying information of the car-mounted device 22 from the memory stick 25. At step S7, the PC 24 transmits the identifying information of the car-mounted device 22 and the image information to the server 26 through the Internet 23.

At step S8, the server 26 converts the format of the image information to meet with the image display specifications of the car-mounted device selected based on the identifying information of the car-mounted device 22. Note that when the image information input to the server 26 consists of a plurality of still images, it converts the format and prepares “slide show” image information from the plurality of still images. At step S9, the server 26 transmits the converted image information to the PC 24 through the Internet 23. At step S10, the server 26 erases the image information and identifying information of the car-mounted device 22 in it. Note that the information is erased so as to prevent the storage capacity of the server 26 from being exceeded. If there is no problem in the storage capacity of the server 26, this step may be skipped.

At step S11, the PC 24 writes the image information in the memory stick 25. At step S12, the memory stick 25 is removed from the PC 24. At step S13, the memory stick 25 is again loaded in the car-mounted device 22. At step S14, the car-mounted device 22 reads the image information from the memory stick 25. At step S15, the read image information is displayed on the display unit 29 in accordance with an operation display control signal of the processing circuit 27. The routine then proceeds to step S16, where the series of operations is ended.

Note that with the image display at the display unit 29 of the car-mounted device 22 at step S15, it is possible to display the image information read out from the memory stick 25 in real time or possible to store the information read out from the memory stick 25 once in the memory unit 30 and read it out from the memory unit 30 for display at any later timing.

In this way, in the image display customizing system 21, image information prepared in advance in the server 26 is not downloaded one-way. A user can send image information prepared by the user itself to the server 26 through the Internet 23, download image information converted by the server 26 to meet the image display specifications of the car-mounted device 22 of the user, and display it on the display unit 29 of the car-mounted device 22. Therefore, regardless of the image display specifications of the car-mounted device 22, a user can display original image information individually prepared by a video camera or digital camera at the car-mounted device 22 so as to enjoy the image.

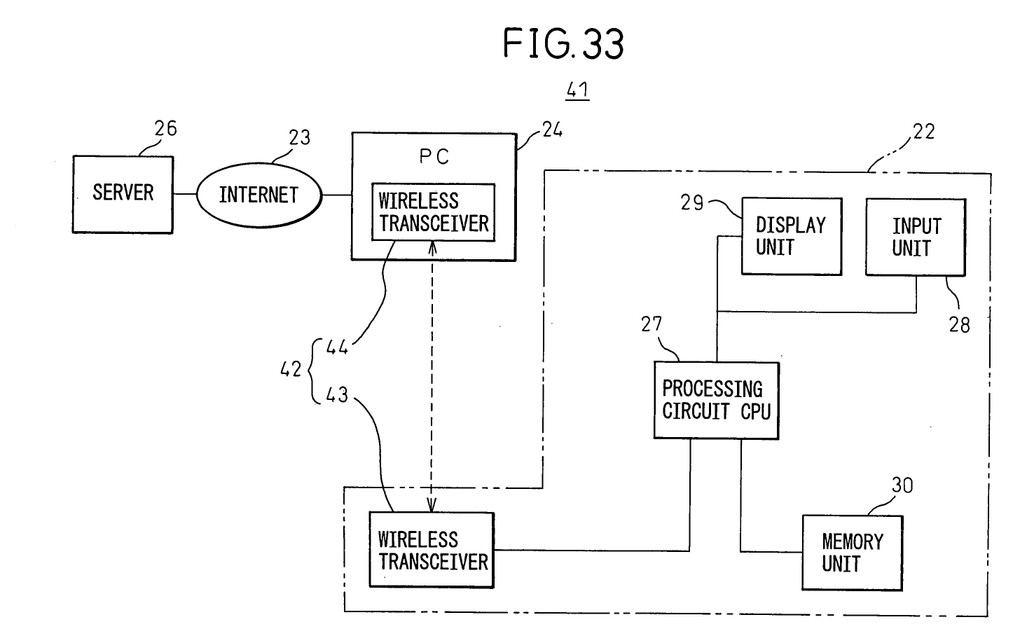

FIG. 33 is a block diagram of an example of the configuration of another image display customizing system 41. The illustrated image display customizing system 41 is similar to the image display customizing system of FIG. 31. Corresponding parts will therefore be assigned the same reference numerals and overlapping explanations will be omitted.

In the image display customizing system 41, the information transmitting function unit 42 is comprised of a first wireless transceiver 43 provided in the car-mounted device 22 and a second wireless transceiver 44 provided in a PC 24. This configuration can be realized by using wireless transceivers based on for example the Bluetooth standard for the first and second wireless transceivers 43 and 44.

By arranging the PC 24 near or in the motor vehicle mounting the car-mounted device 22 and wirelessly communicating between the second wireless transceiver 44 of the PC 24 and the first wireless transceiver 43 of the car-mounted device so as to transfer identifying information of the car-mounted device 22 and image information, it becomes possible to obtain similar effects as the case of the image display customizing system 21 of FIG. 31.

As explained above, in the system shown in FIG. 31 and FIG. 33, the communication network is described as being the Internet, but the invention is not limited to this. For example, it may also be a local area network (LAN) formed in a factory. If the communication network is a LAN, the vehicle on which the car-mounted device is mounted becomes a motor vehicle, lift car, etc. operating in the factory. Further, the flash memory card used as the portable memory medium was described as a memory stick, but the invention is not limited to this. For example, it may also be a Compact Flash™ card or SD memory card.

While the invention has been described with reference to specific embodiments chosen for purpose of illustration, it should be apparent that numerous modifications could be made thereto by those skilled in the art without departing from the basic concept and scope of the invention.

What is claimed is:

1. An information provision system having a terminal unit and a relay unit, wherein:
said terminal unit is operative to transmit terminal identifying information to said relay unit and
said relay unit is operative to add additional information corresponding to the received terminal identifying information to the basic information, process said basic information to user information corresponding to said terminal identifying information, and transmit it to said terminal unit.

2. A relay unit operative to receive terminal identifying information from a terminal unit, add additional information corresponding to the received terminal identifying information to basic information, process said basic information to user information corresponding to said terminal identifying information, and transmit it to said terminal unit.

3. A terminal unit operative to transmit terminal identifying information to a relay unit and to receive from said relay unit user information comprised of additional information corresponding to said terminal identifying information added to basic information and processed to content corresponding to said terminal identifying information.

4. A relay unit as set forth in claim 2, comprising a server or an apparatus linked with a plurality of external servers.

5. A relay unit as set forth in claim 2, provided with a charge information holding function unit for adding up and holding charge information corresponding to said terminal identifying information.

6. A terminal unit as set forth in claim 3, which further is operative to transmit an ID code assigned to the terminal unit to the relay unit and receive user information comprised of the basic information and/or additional information corresponding to said ID code processed by said relay unit to content corresponding to said ID code.

7. A terminal unit as set forth in claim 3, wherein said additional information is vehicle information.

8. A terminal unit as set forth in claim 3, wherein said additional information is preference information of said terminal unit user.

9. A terminal unit operative to transmit terminal identifying information to a relay unit and to receive from said relay unit user information comprised of terminal originated information originated from another terminal unit corresponding to said terminal identifying information added to basic information and processed to content corresponding to said terminal identifying information.

10. A terminal unit as set forth in claim 9, wherein said terminal unit is a car-mounted terminal unit and said terminal originated information includes at least one of four types of information of (a) vehicle position information, (b) vehicle speed information, (c) facility information, and (d) group shared information distributed only among users in a group.

11. An information provision system as set forth in claim 1, wherein said relay unit is operative to process additional information to content corresponding to terminal identifying information and then add information corresponding to said terminal identifying information to said basic information.

12. A relay unit as set forth in claim 2, which is operative to process additional information to content corresponding to terminal identifying information and then add information corresponding to said terminal identifying information to said basic information.

13. A terminal unit as set forth in claim 3, which is operative to receive user information obtained by processing additional information to content corresponding to terminal identifying information and then add information corresponding to said terminal identifying information to said basic information.

14. An image display customizing system of a car-mounted device using a communication network provided with:
a car-mounted device comprised of an electrical apparatus mounted in a vehicle and having a display unit able to display an image,
an information communication terminal able to be connected to a communication network and able to send and receive information through said communication network,
an information transmitting function unit at least able to transmit identifying information of said car-mounted device from said car-mounted device to said information communication terminal and transmit image information from said information communication terminal to said car-mounted device, and an image information converting function unit able to be connected to a communication network, convert image information received through said communication network to image display specifications of a car-mounted device specified by identifying information of said car-mounted device received through said communication network, and transmit said converted image information.

15. An image display customizing system of a car-mounted system using a communication network as set forth in claim 14, wherein said information transmitting function unit is a portable memory medium which is portable, can be freely attached to said car-mounted device and said information communication terminal, and enables writing and reading of identifying information of said car-mounted device and image information between said car-mounted device and information communication terminal.

16. An image display customizing system of a car-mounted system using a communication network as set forth in claim 15, wherein said portable memory medium is a flash memory card.
